(19) United States
(12) Patent Application Publication
(10) Pub. No.: US 2010/0207776 A1
(43) Pub. Date: Aug. 19, 2010

(54) COMMUNICATION DEVICE

(76) Inventors: Shinji Takuno, Tottori (JP); Teruyuki Yorita, Tottori (JP)

Correspondence Address: MCDERMOTT WILL & EMERY LLP, 600 13TH STREET, N.W., WASHINGTON, DC, 20005-3096, US

(21) Appl. No.: 12/678,383

(22) PCT Filed: May 20, 2008
(86) PCT No.: PCT/JP2008/059176

§ 371 Date: Mar. 16, 2010

(30) Foreign Application Priority Data
Sep. 21, 2007 (JP) 2007 245573
Sep. 26, 2007 (JP) 2007 248511
Nov. 20, 2007 (JP) 2007 300288

(51) Int. Cl. G08B 21/00

(52) U.S. Cl. 340/690

(57) ABSTRACT

A communication device of the present invention is provided with an evacuation direction portion receiving an earthquake early warning, and outputting a text image or sound for an evacuation direction. If the earthquake early warning is received under circumstances where a time adjusting portion cannot assure the accuracy of time kept by a timekeeping portion, the evacuation direction portion gives an evacuation direction based on earthquake information unassociated with the time. The evacuation direction portion is provided with a plurality of kinds of evacuation direction images or sounds. The evacuation direction portion determines an image or sound to be used for the evacuation direction based on an expected time period before a main tremor arrives calculated by an earthquake information calculating portion. Moreover, an evacuation direction registering portion receiving from a user, selection of evacuation direction data that the evacuation direction portion uses is provided.

### TECHNICAL FIELD

The present invention relates to a communication device connected to a wide area communications network to perform communications thereover, and particularly, to a communication device receiving an earthquake early warning distributed by the Japan Meteorological Agency, and giving an evacuation direction according to an expected time period before the main tremor of an earthquake arrives.

### BACKGROUND ART

In recent years, as a result of development of communication infrastructures, various additional services involved in communications has been widely spread. For example, telephones that can be connected not only to general telephone lines, but also to wide area communications networks such as an IP telecommunications network and the Internet, and that can receive various kinds of services including data communication services are widely used.

Communication devices, like them, are provided with capabilities, one of which is to receive earthquake early warnings distributed by the Japan Meteorological Agency at the time of earthquake. The earthquake early warning is an information distribution service which, for example in the case of Japan, is put in practical use as of Oct. 1, 2007 A.D. This service is available to users having purchased a communication device compatible with the earthquake early warnings, and subscribed to distribution service providers of the earthquake early warnings.

On receiving the earthquake early warning at the time of earthquake, the communication device calculates the estimated seismic intensity and the expected time when the main tremor (=part of the earthquake that is felt by a human body as the strongest shake, typically S wave) arrives by using area information, such as latitude-longitude information of a location where the communication device is installed, that is stored in advance inside the communication device.

The result of the calculation is notified to the user by, for example, displaying it on a liquid crystal panel, or by outputting it in the form of sound from a loudspeaker. Thus, the user can take evacuation actions, such as taking shelter under a desk and putting out a fire, before the main tremor arrives from the focus.

As a device capable of receiving an earthquake early warning as described above, Patent Document 1 discloses an image processing device that helps reduce, as compared with conventional devices, a possibility that secondary disasters, such as fires, resulting from earthquake may occur. The image processing device is provided with a communication control means for communicating with an external device, and a power supply control means for changing the state of a current flowing inside the device.

The power supply control means is so controlled as to change the state of the current flowing when the communication control means receives the earthquake early warning from the external device. By performing power supply control according to information from outside in this way, it is possible to prevent erroneous detection of an earthquake due to motions caused by nearby construction or by something accidentally hitting the device, other than earthquake shakes, and it is possible to secure safety with no loss of convenience.

In connection with the foregoing, Patent Document 2 discloses a portable earthquake early warning device that can collect earthquake early warnings, and that can judge whether or not it is necessary to make an alert before the main tremor of an earthquake arrives. The portable earthquake early warning device is provided with a location information receiving means, an earthquake early warning receiving means, and an alert necessity judging means for judging whether or not it is necessary to make an alert before the main tremor of the earthquake arrives based on the location information and the earthquake early warning received by the aforementioned two receiving means.

This makes it possible to make an alert in railway cars and automobiles before the main tremor of the earthquake arrives; thus it is possible to take a prompt action to stop the railway cars and automobiles, etc., and to prevent a catastrophe from occurring thereby.

[Patent Document 1] JP-A-2007-72917

[Patent Document 2] JP-A-2005-283491

### DISCLOSURE OF THE INVENTION

### Problems to be Solved by the Invention

According to Patent Documents 1 and 2 described above, by receiving an earthquake early warning, it is possible to prevent a secondary disaster, and to make an alert and to take an action, etc. so as to stop railway cars and automobiles before the main tremor arrives. However, regarding sound messages and text messages for making an alert, fixed messages preinstalled in the communication device are used as conventionally practiced.

However, the expected time period from the occurrence of an earthquake until the arrival of its main tremor varies differently according to the magnitude of the earthquake and the distance to the focus. For example, if the expected time period is 20 seconds, a user can afford to take an evacuation action. By contrast, if the expected time period is as short as three seconds, the user is only allowed to take the minimum evacuation action, such as taking cover under a desk.

The conventional communication devices employ the fixed messages, and thus cannot give evacuation directions according to the conditions as described above. Moreover, they cannot use different evacuation directions according to their installation locations. Accordingly, users who have lost their calm, small children, or elderly persons may not take appropriate evacuation actions, and may thus encounter unfavorable situations, such as immediately taking shelter under a desk regardless of a long expected time period, checking sources of flames regardless of a short expected time period, and failing to find an evacuation spot.

When an internal clock incorporated in a receiver has an incorrect date and time, an error occurs that the expected arrival time is calculated based on the incorrect date and time. Moreover, if the internal clock is stopped, it is impossible to calculate the expected arrival time; thus a problem arises that an evacuation direction function cannot work.

The present invention is devised to solve the above-described problems, and thus has an object to provide a communication device that, when receiving an earthquake early warning as a result of an earthquake, can give a user an optimum evacuation direction according to an expected time period before a main tremor arrives and a location where the communication device is installed. Moreover, another object is to provide a communication device that, when receiving an earthquake early warning, can give an appropriate direction even under circumstances where the accuracy of an internal clock cannot be assured or where the internal clock is disabled.

### Means for Solving the Problem

A communication device according to the present invention is provided with: a first communication portion capable of establishing connection with a communications network; an earthquake information calculating portion receiving an earthquake early warning from the communications network by using the first communication portion, and calculating earthquake information including an expected time period before a main tremor arrives; an evacuation direction portion outputting an evacuation direction image or an evacuation direction sound based on the earthquake information by using a display portion and a sound outputting portion, a timekeeping portion keeping time, and a time adjusting portion adjusting the timekeeping portion, wherein when the earthquake information calculating portion receives the earthquake early warning under circumstances where the time adjusting portion cannot assure accuracy of the timekeeping portion, the evacuation direction portion is prohibited from outputting an evacuation direction image and an evacuation direction sound associated with the earthquake information calculated, by the earthquake information calculating portion, based on the time, and the evacuation direction portion outputs an evacuation direction image or an evacuation direction sound unassociated with the earthquake information.

According to this construction, the communication device of the present invention is provided with the first communication portion capable of establishing connection with the communications network, examples of which include a network card and a wireless LAN device. The earthquake information calculating portion is provided that receives the earthquake early warning distributed by the Japan Metrological Agency from a wide area communications network such as the Internet, by using the first communication portion. The evacuation direction portion is provided that outputs a text image or sound for an evacuation direction by using the display portion, such as a liquid crystal monitor, and a loudspeaker. The timekeeping portion keeping current time and the time adjusting portion adjusting the timekeeping portion are provided.

Moreover, according to this construction, in the communication device of the present invention, at the time of receiving the earthquake early warning under circumstances where the time adjusting portion cannot assure the accuracy of the time kept by the timekeeping portion, the evacuation direction portion gives an evacuation direction based on the earthquake information unassociated with the time. For example, no processing is performed including processing for notifying of the expected arrival time of the main tremor, processing for counting down the estimated time period before arrival, etc. Instead, the evacuation direction is given without using the time information; for example, the least notification is made of earthquake occurrence or the estimated seismic intensity.

In the communication device of the present invention, the time adjusting portion judges that the accuracy of the timekeeping portion cannot be assured, if the time adjusting portion performs communication with an NTP (Network Time Protocol) server by using the first communication portion, and fails to acquire time information from the server, or if the time adjusting portion detects that the timekeeping portion is disabled.

According to this construction, the time adjusting portion of the present invention makes access to the NTP server by using the first communication portion at regular intervals. The time adjusting portion acquires the time information from the NTP server and, based on that time information, adjusts the time of the timekeeping portion. If the time adjusting portion cannot perform communication with the NTP server due to communication error, etc., or if the time adjusting portion can perform communication with the NTP server but cannot acquire the time information from the server, the time adjusting portion judges that the accuracy of the timekeeping portion cannot be assured. Moreover, if detecting that the timekeeping portion is disabled, the time adjusting portion judges that the accuracy of the timekeeping portion cannot be assured. As a result, the evacuation direction portion gives an evacuation direction based on the earthquake information unassociated with the time. Incidentally, if the time adjusting portion can acquire the time information without problems, or if the time adjusting portion detects the timekeeping portion is operating correctly, the evacuation direction portion returns to a state giving a normal evacuation direction.

The communication device of the present invention is further provided with: a temperature measuring portion measuring temperature; a temperature monitoring portion monitoring whether or not the temperature measured by the temperature measuring portion is within a predetermined range; a date/area checking portion judging whether or not date information acquired from the timekeeping portion matches a predetermined date, and judging whether or not area information of the communication device stored in a storage portion matches a predetermined area, wherein when the earthquake information calculating portion receives the earthquake early warning under circumstances where the temperature monitoring portion detects that the temperature measured is out of the range or the date/area checking portion judges that there is a match for the date or the area, the evacuation direction portion is prohibited from outputting the evacuation direction image and evacuation direction sound associated with the earthquake information calculated, by the earthquake information calculating portion, based on the time, and the evacuation direction portion outputs the evacuation direction image or evacuation direction sound unassociated with the earthquake information.

According to this construction, the communication device of the present invention is further provided with: the temperature measuring portion measuring temperature; and the temperature monitoring portion monitoring whether or not the temperature measured by the temperature measuring portion is within a predetermined range. The temperature monitoring portion judges that the accuracy of the timekeeping portion cannot be assured if the temperature measured is detected to be above or below the predetermined range. The date/area checking portion is provided that acquires calendar information such as the current month, day, and day of the week, and that judges whether or not the current date matches a predetermined date, such as a date indicating a winter or a summer season. Moreover, the date/area checking portion judges whether or not area information of the communication device, namely an installation location of the communication device stored in the storage portion matches a predetermined area. If judging that there is a match for the date or area, the date/area checking portion judges that the accuracy of the timekeeping portion cannot be assured.

If it is judged that the accuracy cannot be assured in this way, the evacuation portion give an evacuation direction based on the earthquake information unassociated with the time. Incidentally, if the temperature monitoring portion detects that the temperature measured falls within the range, or if the date and the area no longer meet the criterion, the evacuation direction portion returns to the state giving the normal evacuation direction.

The communication device of the present invention is further provided with a storage portion storing first evacuation direction data including the evacuation direction image or the evacuation direction sound associated with time and second evacuation direction data including the evacuation direction image or the evacuation direction sound unassociated with the time, wherein when the earthquake information calculating portion receives the earthquake early warning under circumstances where the time adjusting portion cannot assure the accuracy of the timekeeping portion, the evacuation direction portion outputs, as an evacuation direction, the evacuation direction image or the evacuation direction sound by using the second evacuation direction data.

According to this construction, in the communication device of the present invention, the storage portion, such as a memory, stores the first evacuation direction data including the evacuation direction image or the evacuation direction sound associated with the time. The data is composed of, for example, images and sounds indicating the expected arrival time of the main tremor and the time period allowed before arrival. Moreover, the storage portion stores the second evacuation direction data including the evacuation direction image or the evacuation direction sound unassociated with the time. The data is composed of, for example, images and sounds for making the least notification of the earthquake occurrence or the estimated seismic intensity. At the time of receiving the earthquake early warning under circumstances where the accuracy of the timekeeping portion cannot be assured, the evacuation direction portion reads the second evacuation direction data, and then gives an evacuation direction.

In the communication device of the present invention, the evacuation direction portion is provided with, as such the evacuation direction image and the evacuation direction sound, a plurality of kinds of evacuation direction images or sounds and, based on the expected time period, finds and outputs the evacuation direction image or the evacuation direction sound to be used for the evacuation direction.

According to this construction, the communication device of the present invention is provided with the evacuation direction portion outputting a text image or sound for the evacuation direction by using the display portion, such as a liquid crystal monitor, and the sound outputting portion, such as a loudspeaker, at the time of receiving the earthquake early warning. The evacuation direction portion is provided with, as such the evacuation direction image and the evacuation direction sound, the plurality of kinds of evacuation direction images and evacuation direction sounds. Based on the expected time period before the main tremor arrives calculated by the earthquake information calculating portion, the evacuation direction portion determines an image and a sound to be used for the evacuation direction. Thus, it is possible to given an evacuation direction while changing the contents of the direction according to the expected time period decrementing as the time elapses.

The communication device is further provided with a storage portion storing an association table in which the expected time period and contents of the evacuation direction corresponding to the expected time period are associated with each other, wherein the evacuation direction portion finds the contents of the evacuation direction corresponding to the expected time period by referring to the association table and, based on a result found, outputs the evacuation direction image or the evacuation direction sound.

According to this construction, the communication device of the present invention is provided with the storage portion such as a memory. The storage portion stores the association table in which the expected time and a plurality of guidances (=the contents of the evacuation direction) to be used according to the length of the expected time period are associated with each other. To direct a user to take an evacuation direction, the evacuation direction portion reads the association table from the storage portion, and finds the guidance corresponding to the expected time period. The evacuation direction portion gives an evacuation direction by using the evacuation direction image and the evacuation direction sound corresponding to that guidance.

In the communication device of the present invention, the evacuation direction portion updates the expected time period as the time elapses, and for each updating, checks the expected time period so updated with the association table, and then judges whether or not it is necessary to change the evacuation direction image or the evacuation direction sound to be outputted.

According to this construction, the evacuation direction portion is fed with the expected time period to store it temporarily in the memory, and updates the predetermined time period every time a predetermined time elapses, for example every second. For each updating, the evacuation direction portion gives an evacuation direction based on the guidance corresponding to the expected time period so updated. Thus, for example in a case where the communication device is composed of a plurality of units including a base unit and handsets, the base unit transmits the expected time period to the handsets only once whereby the handsets can give a direction to take an evacuation action according to the time elapsed.

In the communication device, the evacuation direction portion determines the evacuation direction image or the evacuation direction sound to be used for the evacuation direction, based on the estimated seismic intensity and the expected time period included in the earthquake information.

According to this construction, the evacuation direction portion finds the guidance to be used for the evacuation direction, based on the values of the expected time period and the estimated seismic intensity. Thus, for example even when the expected time period is long, if the estimated seismic intensity is extremely great, it is possible to give an evacuation direction that prioritizes a protection action such as taking cover under a desk.

The communication device comprises: a main communication device including the first communication portion, the earthquake information calculating portion, the evacuation direction portion, the timekeeping portion, the time adjusting portion, and an earthquake information transmitting portion transmitting the earthquake information and the status of the accuracy of the timekeeping portion, namely whether or not the accuracy of the timekeeping portion can be assured, by using the first communication portion; and a subsidiary communication device including a second communication portion capable of performing communication with the main communication device, an earthquake information acquiring portion acquiring, from information received by using the second communication portion, the earthquake information and the status of the accuracy of the timekeeping portion, namely whether or not the accuracy of the timekeeping portion can be assured, and the evacuation direction portion.

According to this construction, the communication device of the present invention is so constructed as to include a base unit (=the main communication device) and a handset (=the subsidiary communication device). The base unit is provided with the first communication portion, the earthquake information calculating portion, the evacuation direction portion, the timekeeping portion, and the time adjusting portion. Moreover, the base unit is provided with the earthquake information transmitting portion transmitting to the handset, the earthquake information and the status of the accuracy of the timekeeping portion, namely whether or not the accuracy of the timekeeping portion can be assured when the earthquake information calculating portion receives the earthquake early warning.

On the other hand, the handset is provided with the second communication portion capable of performing communication with the base unit, and the earthquake information acquiring portion extracting from the information received by the second communication portion, the earthquake information transmitted from the base unit and the status of the accuracy of the timekeeping portion, namely whether or not the accuracy of the timekeeping portion can be assured. Moreover, the handset is provided with the evacuation direction portion. Thus, the base unit and the handset can give an evacuation direction to direct a user to take an evacuation action while changing the contents of the evacuation direction to be outputted according to the length of the expected time period before the main tremor arrives. Based on the status of the accuracy so acquired, namely whether or not the accuracy can be assured, the evacuation direction portion determines whether or not to give an evacuation direction by using the earthquake information associated with the time or by using the earthquake information unassociated with the time.

In the communication device of the present invention, the first communication portion is provided with a wireless communication portion capable of performing communication with a wireless communications network, the earthquake information transmitting portion transmits to the subsidiary communication device, the earthquake information and the status of the accuracy of the timekeeping portion, namely whether or not the accuracy of the timekeeping portion can be assured, by using the wireless communication portion provided in the first communication portion, the second communication portion is provided with a wireless communication portion capable of performing communication with the wireless communication network, and the earthquake information receiving portion receives the earthquake information and the status of the accuracy of the timekeeping portion, namely whether or not the accuracy of the timekeeping portion can be assured, by using the wireless communication portion incorporated in the second communication device.

According to this construction, the base unit and the handset are each provided with the wireless communication portion including an antenna device capable of establishing connection with the wireless communications network. In the base unit, the earthquake information transmitting portion transmits to the handset, the earthquake information and information indicating whether or not the accuracy of the timekeeping portion, by using the wireless communications portion. In the handset, the earthquake information receiving portion receives the earthquake information transmitted from the base unit and the information indicating whether or not the accuracy of the timekeeping portion can be assured, by using the wireless communication portion. This eliminates the need for connecting the base unit and the handset together by use of a wired communications network; accordingly, while the user is using the handset remotely, it is possible to give a direction to take an evacuation action according to the length of the expected time period and the accuracy of the timekeeping portion.

In the communication device, the subsidiary communication device is further provided with a storage portion storing an association table in which the expected time period and contents of the evacuation direction are associated with each other, wherein the earthquake information transmitting portion updates the expected time period as the time elapses and, for each updating, transmits the expected time period so updated to the subsidiary communication device by using the first communication portion, and the evacuation direction portion provided in the subsidiary communication device finds the contents of the evacuation direction corresponding to the expected time period by referring to the association table and, based on a result found, outputs the evacuation direction image or the evacuation direction sound, and judges whether or not it is necessary to change the evacuation direction image or the evacuation direction sound to be outputted, by checking the expected time period with the association table, every time receiving the expected time period.

According to this construction, in the base unit, the evacuation direction portion updates the expected time period every time a predetermined time elapses, for example every second. Then, for each updating, the base unit transmits the value indicating the expected time period so updated to the handset, by using the first communication portion. Accordingly, the handset needs not to perform processing for updating the expected time period at predetermined time intervals; thus it is possible to simplify the evacuation direction processing performed in the handset.

A communication device of the present invention is provided with: a first communication portion capable of establishing connection with a communications network; a warning receiving portion receiving an earthquake early warning from the communications network by using the first communication portion; and an evacuation direction portion outputting an evacuation direction image or an evacuation direction sound by using a display portion or a sound outputting portion, at the time of receiving the earthquake early warning, wherein the evacuation direction portion incorporates, as such the evacuation direction image or the evacuation direction sound, a plurality of kinds of evacuation direction images or evacuation direction sounds, and the communication device includes an evacuation direction registering portion receiving a result of specification of the evacuation direction image or the evacuation direction sound to be used by the evacuation direction portion at the time of receiving the earthquake early warning.

According to this construction, the communication device of the present invention is provided with the first communication device including a network card, a wireless LAN device or the like that can establish connection with the communications network. The communication device is provided with the warning receiving portion receiving the earthquake early warning distributed by the Japan Metrological Agency from the wide area communications network such as the Internet by using the first communication portion.

Moreover, the communication device is provided with the evacuation direction portion outputting, at the time of receiving the earthquake early warning, a text image or a sound for the evacuation direction by using the display portion such as a liquid crystal monitor or the sound outputting portion such as a loudspeaker. The communication portion is provided with the evacuation direction registering portion receiving from a user, a result of specifying which of the evacuation direction images or the evacuation direction sounds the evacuation direction portion uses to given an evacuation direction. Accordingly, the evacuation direction portion gives an evacuation direction by using the evacuation direction images or the evacuation direction sounds registered by the evacuation direction registering portion in advance.

The communication device is further provided with a storage portion, wherein the evacuation direction registering portion receives image data or sound data to be stored in the storage portion, and receiving a result of selection of the evacuation direction image or the evacuation direction sound to be used as the evacuation direction by the evacuation direction portion, from among the image data or the sound data stored in the storage portion.

According to this construction, the communication device of the present invention is provided with the storage portion such as a flash memory. The evacuation direction registering portion receives the image data and sound data to be used for the evacuation direction, and stores them in the storage portion. The evacuation direction portion receives the result of selection of the evacuation direction image and the evacuation direction sound to be used by the evacuation direction portion, from among the sound data and image data stored in the storage portion. The result of specification is then stored in the storage portion, and referred to by the evacuation direction portion at the time of receiving an earthquake early warning. In this way, a sound and an image that the evacuation direction portion outputs are determined.

In the communication device of the present invention, the storage portion stores an evacuation direction table in which an installation location of the communication device, and the evacuation direction image or the evacuation direction sound are associated with each other, the evacuation direction registering portion receives a result of selection of the installation location contained in the evacuation direction table, and the evacuation direction portion finds and outputs the evacuation direction image or the evacuation direction sound associated with the installation location thus specified, from the evacuation direction table.

According to this construction, in the communication device of the present invention, the storage portion stores the evacuation direction table in which the installation location of the communication device and the evacuation direction image and the evacuation direction sound are associated with each other. The evacuation direction registering portion receives from the user, the instruction to select the installation location contained in the evacuation direction table. Then the evacuation direction portion, when giving an evacuation direction, finds and outputs the evacuation direction image and the evacuation direction sound corresponding to the installation location thus specified, by referring to the evacuation direction table at the time of giving an evacuation direction.

The communication device of the present invention is provided with: a main communication device provided with the first communication portion, the warning receiving portion, the evacuation direction portion, the evacuation direction registering portion, an earthquake detection transmitting portion transmitting a detection notification that an earthquake early warning is detected, by using the first communication portion; and a subsidiary communication device provided with a second communication portion capable of performing communication with the main communication device, an earthquake detection receiving portion receiving the detection notification by using the second communication portion, the evacuation direction portion, and the evacuation direction registering portion.

According to this construction, the communication device of the present invention is so constructed as to include the base unit and the handset. The base unit is provided with the first communication portion, the warning receiving portion, the evacuation direction portion, and the evacuation direction registering portion. Moreover, the base unit is provided with the earthquake detection transmitting portion transmitting to the handset, a detection notification that the earthquake early warning is detected, by using the first communication portion, when the warning receiving portion receives the earthquake early warning.

Moreover, the handset is provided with the second communication portion capable of performing communication with the base unit, and the earthquake detection receiving portion extracting from various information received by the second communication portion, the detection notification that the earthquake early warning is detected, transmitted from the base unit. The handset is provided with the evacuation direction portion and the evacuation direction registering portion. With this design, it is possible to register evacuation direction data and give an evacuation direction at the both sides of the base unit and the handset.

In the communication device of the present invention, the first communication portion is provided with a wireless communication portion capable of establishing connection with a wireless communications network, the earthquake detection transmitting portion transmits to the subsidiary communication device, the detection notification, by using the wireless communication portion provided in the first communication portion, the second communication portion is provided with a wireless communication portion capable of establishing connection with the wireless communications network, and the earthquake detection receiving portion receives the detection notification by using the wireless communication portion provided in the second communication portion.

According to this construction, in the communication device of the present invention, the base unit and the handset are each provided with the wireless communication portion including an antenna device capable of establishing connection with the wireless communications network. In the base unit, the earthquake detection transmitting portion transmits the detection notification that the earthquake early warning is detected, by using the wireless communication portion. In the handset, the earthquake detection receiving portion receives the detection notification transmitted from the base unit, by using the wireless communication portion. This eliminates the need for connecting the base unit and the handset together by use of a wired communications network; accordingly, while the user is using the handset remotely, it is still possible to register evacuation direction data and to given an evacuation direction.

### ADVANTAGES OF THE INVENTION

According to the present invention, at the time of receiving the earthquake early warning under circumstances where the accuracy of the time kept by the timekeeping portion, the evacuation direction portion gives an evacuation direction including a vague expression (hereinafter, referred to as “vague notification”) based on the earthquake information unassociated with the time. For example, an image or a sound representing vaguely the expected time period before the main tremor arrives is outputted. Thus, it is possible to prevent a notification of an incorrect expected time period, etc. due to an error occurring in the timekeeping portion. Accordingly, it is possible to give an appropriate evacuation direction according to the status of the timekeeping portion without giving incorrect information to a user.

According to the present invention, the time adjusting portion makes access to the NTP server by using the first communication portion at regular intervals. If the time adjusting portion fails to acquire the time information from the NTP server, or if the timekeeping portion is detected to be disabled, the time adjusting portion judges that the accuracy of the timekeeping portion cannot be assured, and then switches to the vague notification. Thus, it is possible to judge the accuracy of the timekeeping portion easily. Moreover, it is possible to prevent an error in which, owing to the timekeeping portion being disabled, no earthquake information is calculated, and thus no evacuation direction is given.

According to the present invention, if the temperature measuring portion detects that the temperature measured is out of the predetermined range, or if the current date and the installation location match the predetermined date and area, the time adjusting portion judges that the accuracy of the timekeeping portion cannot be assured, and switches to the vague notification. This is because the accuracy of the clock circuit is lowered when the temperature observed is extremely high or extremely low, or during a summer season at which the temperature is expected to be high, or in Hokkaido, etc. where the temperature is expected to be low. According to the present invention, under the circumstances as described above, it is possible to give an evacuation direction with no notification of an incorrect expected arrival time, etc.

According to the present invention, the storage portion, such as the memory, stores the first evacuation direction data for giving a normal evacuation direction and the second evacuation direction data for making a vague notification. If the accuracy of the timekeeping portion cannot be assured, the evacuation direction portion gives an evacuation direction by using the second evacuation data. Different kinds of evacuation direction data according to the conditions are prepared in this way; thus, the evacuation direction portion can switch how the evacuation direction is given easily and surely.

According to the present invention, when the expected time period before the main tremor arrives is calculated, the image and the sound to be used for the evacuation direction are determined based on the length of the expected time period. Thus, it is possible to give an evacuation direction while changing the contents of the direction according to the length of the expected time period decrementing as the time elapses. Accordingly, the user can take an appropriate evacuation action at the time of earthquake; this helps achieve enhanced safety.

According to the present invention, the storage portion, such as the memory, stores the association table in which the expected time period and the contents of the evacuation action are associated with each other. The evacuation direction portion is fed with the expected time period to find the evacuation direction corresponding that time period by referring to the association table read from the storage portion. Thus, it is possible to perform the processing for finding the evacuation direction easily and surely. Moreover, it is possible to change the contents of the evacuation direction later, leading to an increase in versatility.

According to the present invention, the evacuation direction portion updates the expected time period every time the predetermined time elapses, and given an evacuation direction according to the expected time period so updated. Thus, for example, the base unit transmits the expected time period to the handset simply once whereby the handset can give an evacuation direction according to the expected time period. Thus, it is possible to implement the present invention simply by adding functions to the handset, without adding new functions to the base unit; this helps achieve an increase in versatility.

According to the present invention, the evacuation direction is given by changing the contents of the evacuation direction according to the value of the estimated seismic intensity. Thus, for example, when the expected time period is long, and the estimated seismic intensity is great, the direction with protecting the user prioritized is given; this helps achieve enhanced safety for the user.

According to the present invention, the base unit and the handset are included; the base unit transmits to the handset, the earthquake information and information related to the accuracy of the timekeeping portion. Thus, under circumstances where the accuracy of the timekeeping portion in the base unit cannot be assured, it is possible to switch to giving an evacuation direction using a vague expression, and to give an appropriate evacuation direction to the user, in the handset as well.

According to the present invention, the base unit and the handset are each provided with the wireless communication portion, and transmit and receive the expected time period via the wireless communications network. Thus, the user can receive the evacuation direction even when using the handset remotely. Accordingly, the user can take an evacuation action according to the expected time period and the accuracy of the timekeeping portion in the base unit, for example, when moving from a private room to a kitchen; this helps achieve an increase in convenience.

According to the present invention, the earthquake information transmitting portion in the base unit updates the expected time period every time the predetermined time elapses and, for each updating, transmits the expected time period to the handset. Thus, the evacuation directions given by a plurality of handsets produce no difference in contents among them. Accordingly, it is possible to prevent the users from failing to judge which is a correct evacuation direction, and from getting confused. Moreover, it is possible to reduce functions assigned to the handset, leading to a decrease in cost and an increase in maintainability.

According to the present invention, when the earthquake early warning is detected, the evacuation direction is given by using the evacuation direction image and the evacuation direction sound of which the evacuation direction registering portion has received the result of selection in advance. Thus, it is possible to change the contents of the direction according to the installation location of the communication device, age group of a user to whom the evacuation direction is to be given, etc. This permits the user to take an appropriate evacuation action according to his or her surrounding conditions; this helps achieve enhanced safety.

According to the present invention, it is possible to select the evacuation direction image and the evacuation direction sound for the evacuation direction portion to use, from among the sound data and the image data stored in the storage portion. Thus, by storing in the storage portion, image data of an evacuation spot shot by a digital camera, and an evacuation direction sound, etc. recorded by the user, the user can give an evacuation direction using these data. Accordingly, it is possible to tailor the contents of the evacuation direction in detail, leading to an increase in user's convenience and in versatility of the device.

According to the present invention, the evacuation direction table is provided in which the installation location of the communication device, and the evacuation direction image and evacuation direction sound are associated with each other. Thus, simply by specifying the installation location, the user can set the evacuation direction image and evacuation direction sound corresponding to each installation location. Thus, it is possible to accomplish setting operation easily and in a short time, leading to an increase in convenience.

According to the present invention, with both the base unit and the handset, it is possible to give an evacuation direction by using the evacuation direction image and evacuation direction sound registered or selected by the user in advance. Thus, the user, without the base unit nearby, can receive the direction from the handset, and can take an evacuation action; this helps achieve an increase in convenience.

According to the present invention, the base unit and the handset are each provided with the wireless communication portion, and give an evacuation direction via a wireless communications network. Thus, even while using the handset remotely, the user can receive an evacuation direction using the evacuation direction image and evacuation direction sound that the user has registered or selected. Moreover, for example, when the handset is moved from a bed room to a kitchen, it is possible to set the evacuation direction again to suit the kitchen. Thus, even when the installation location of the handset is changed, it is possible to change the contents of the evacuation direction easily according to the conditions.

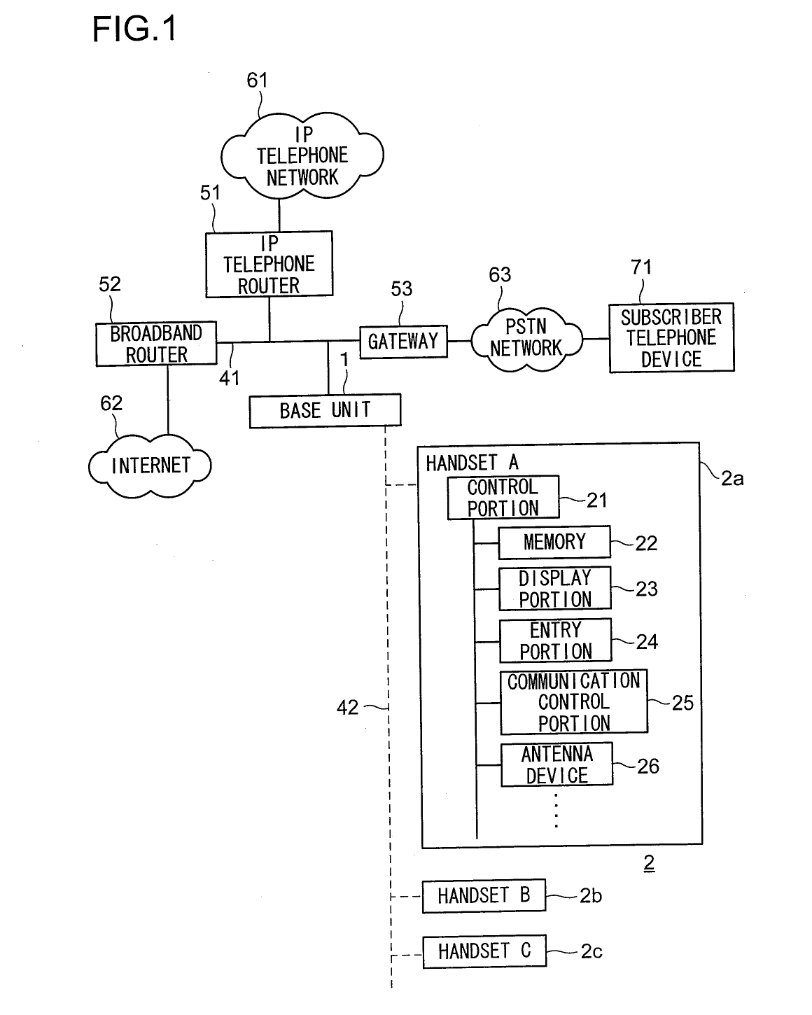

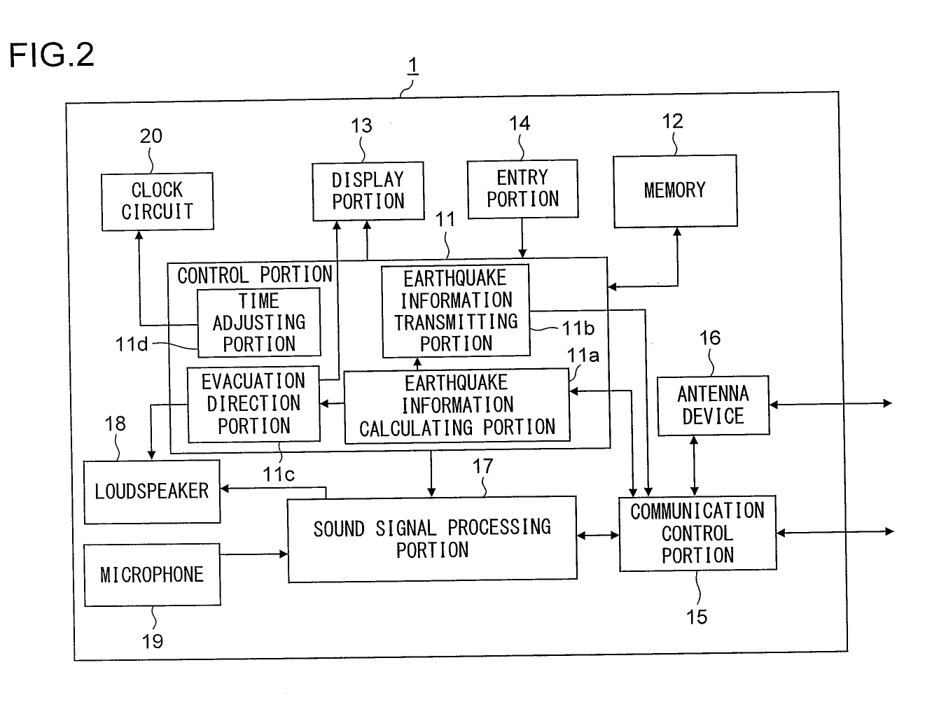

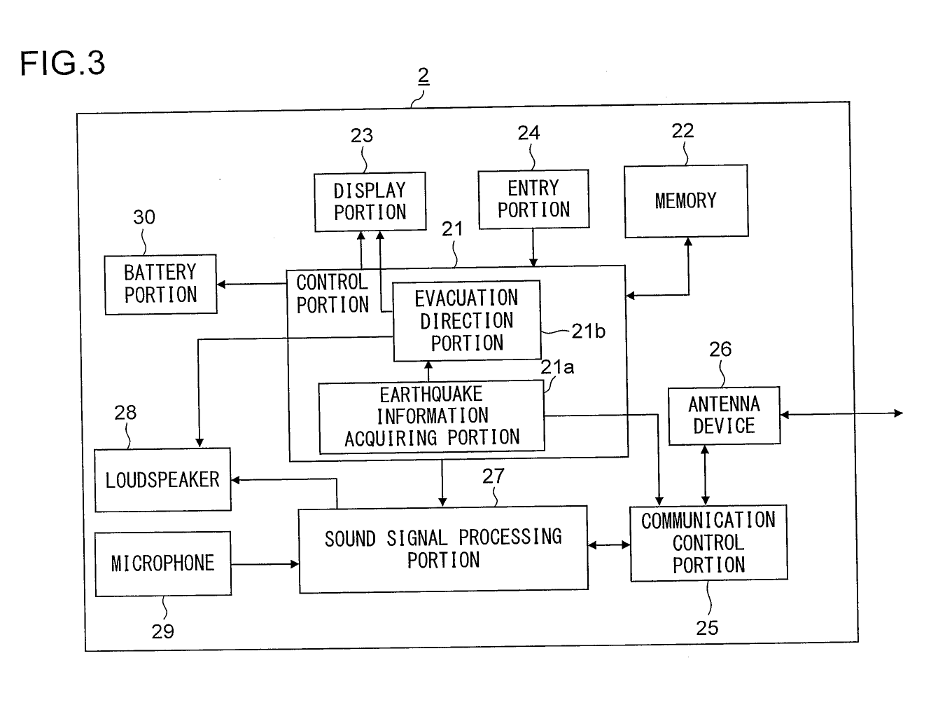

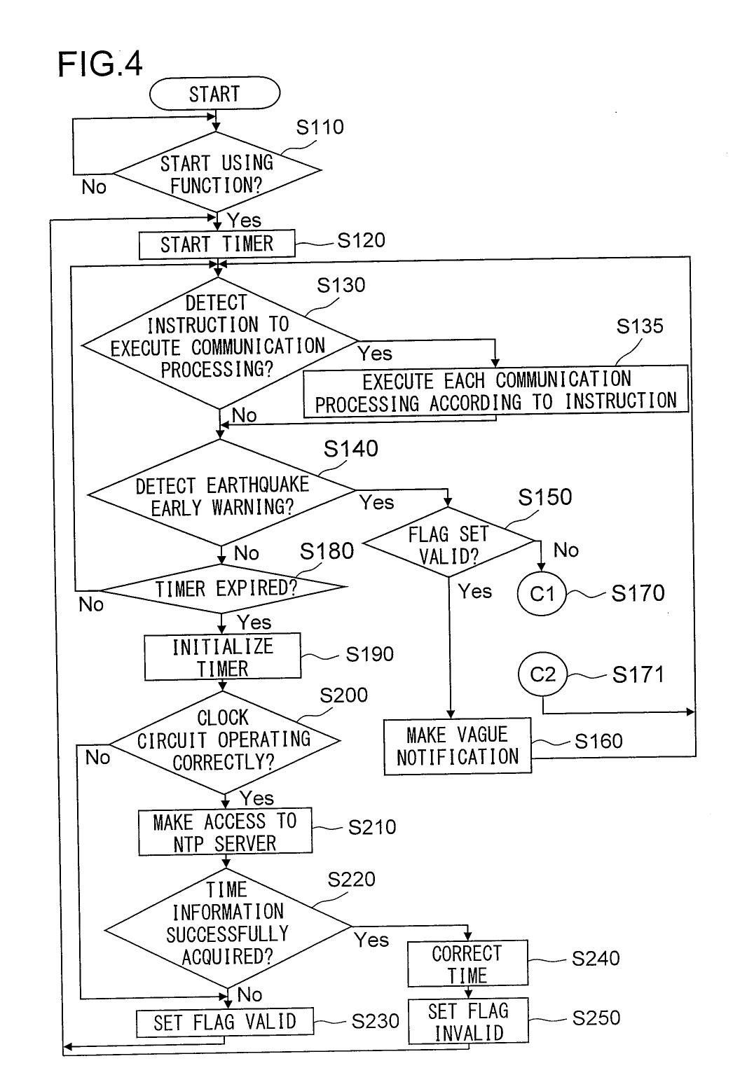

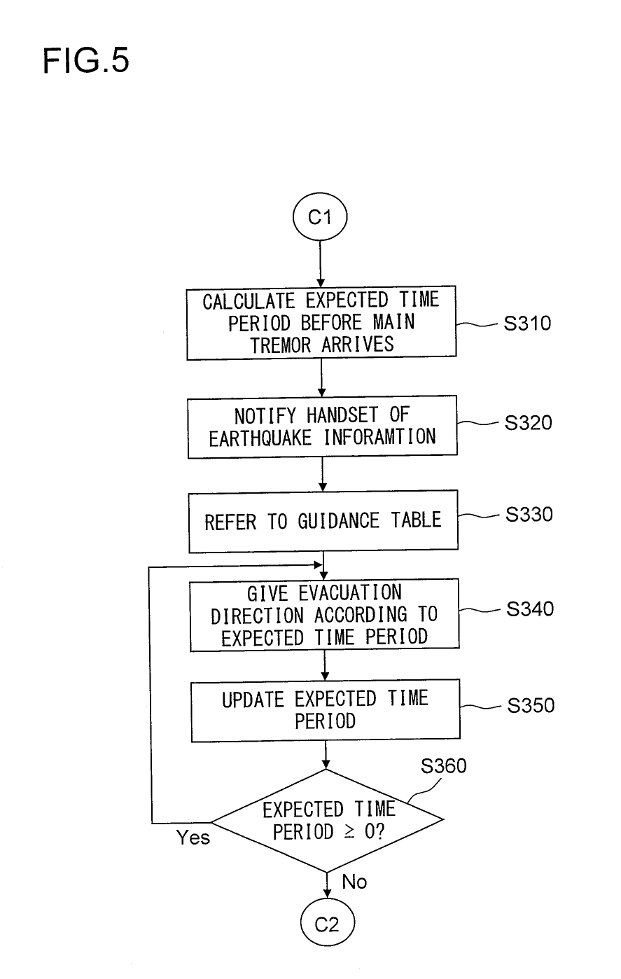

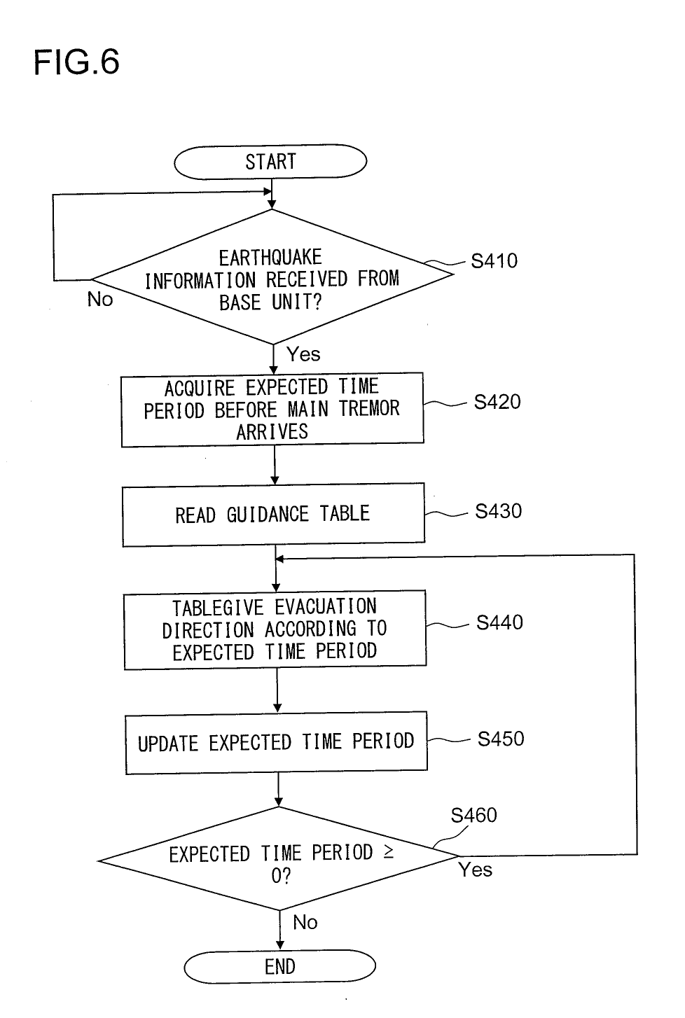

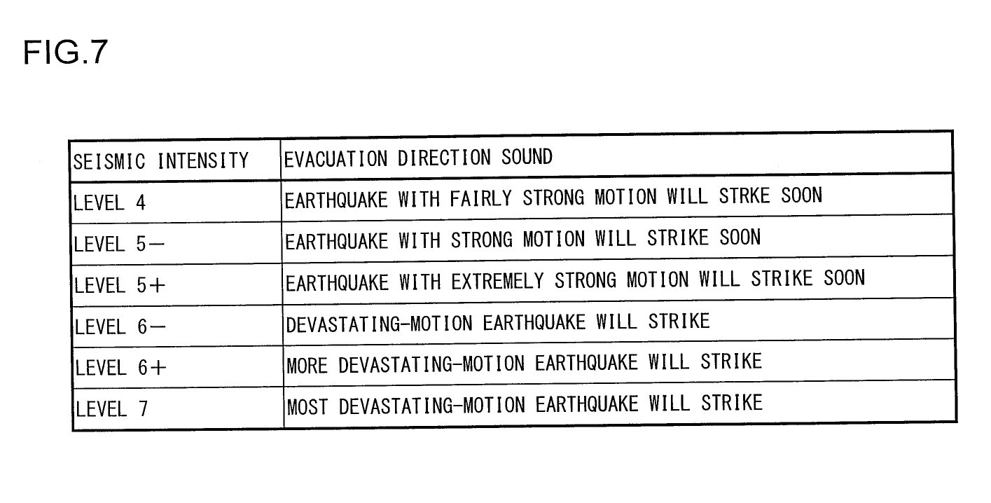

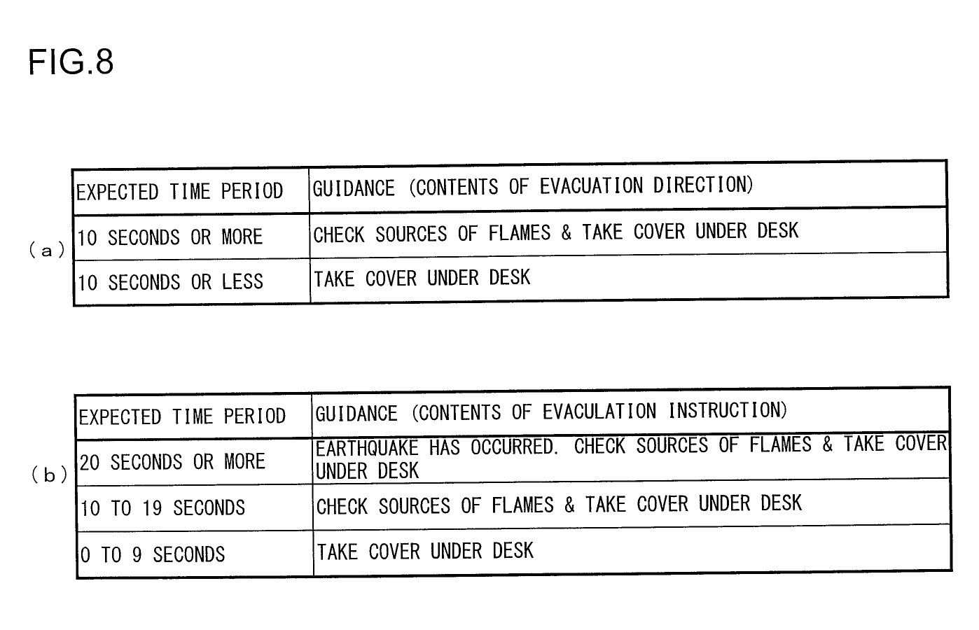

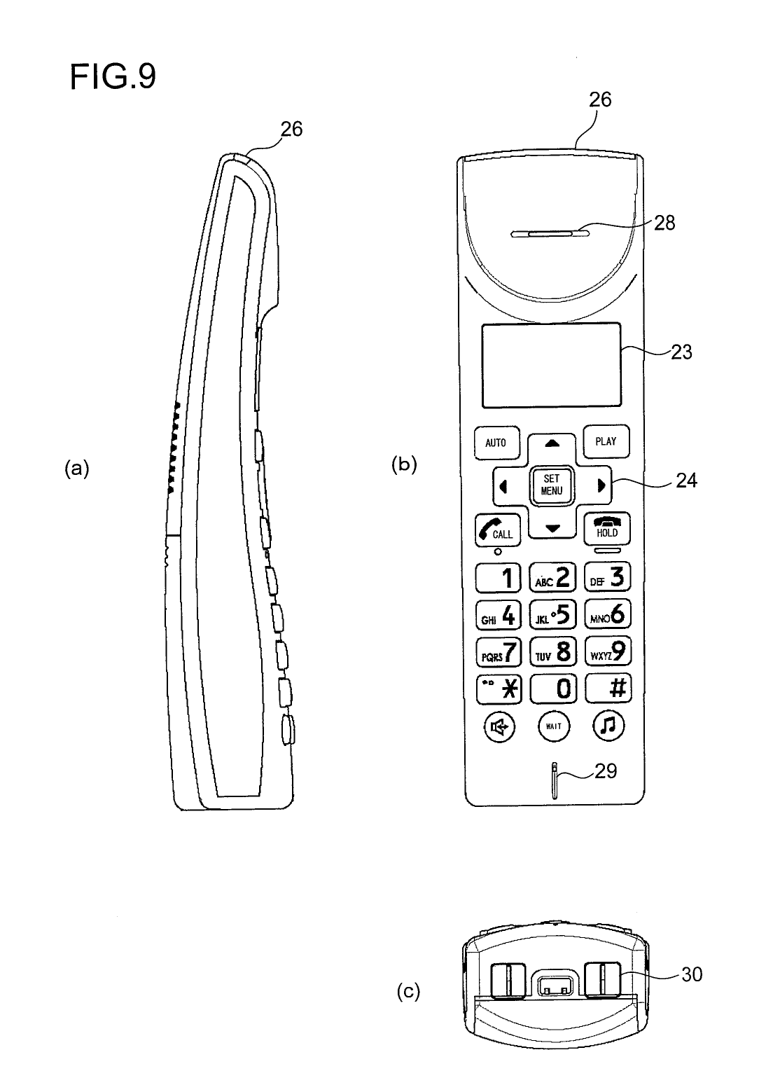

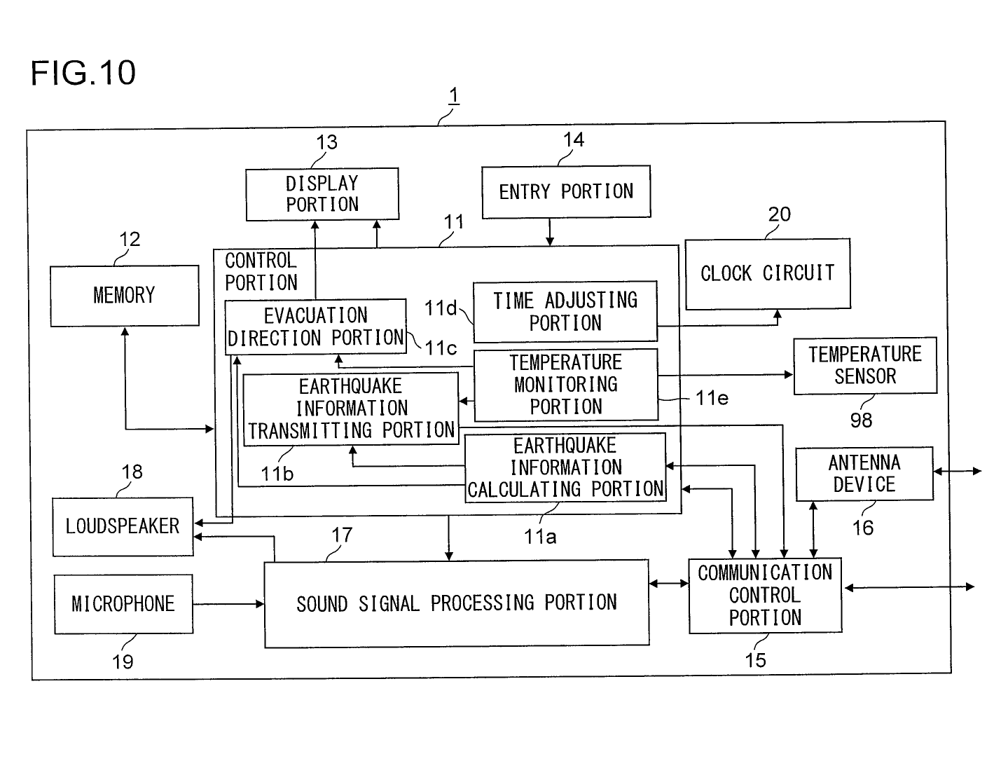

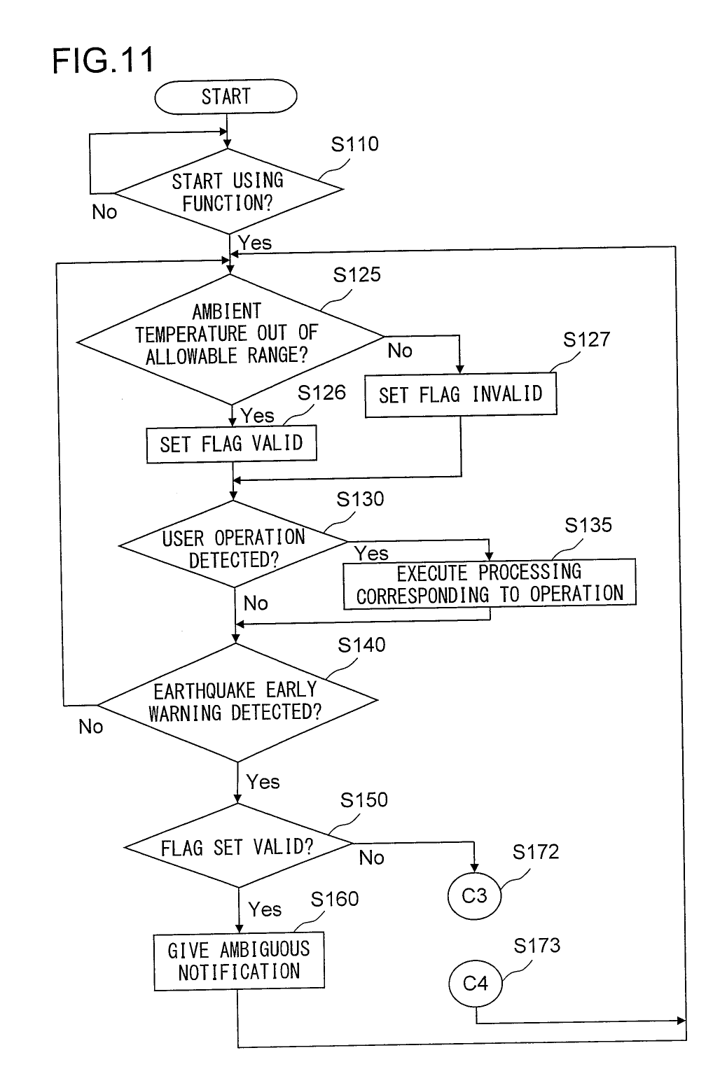

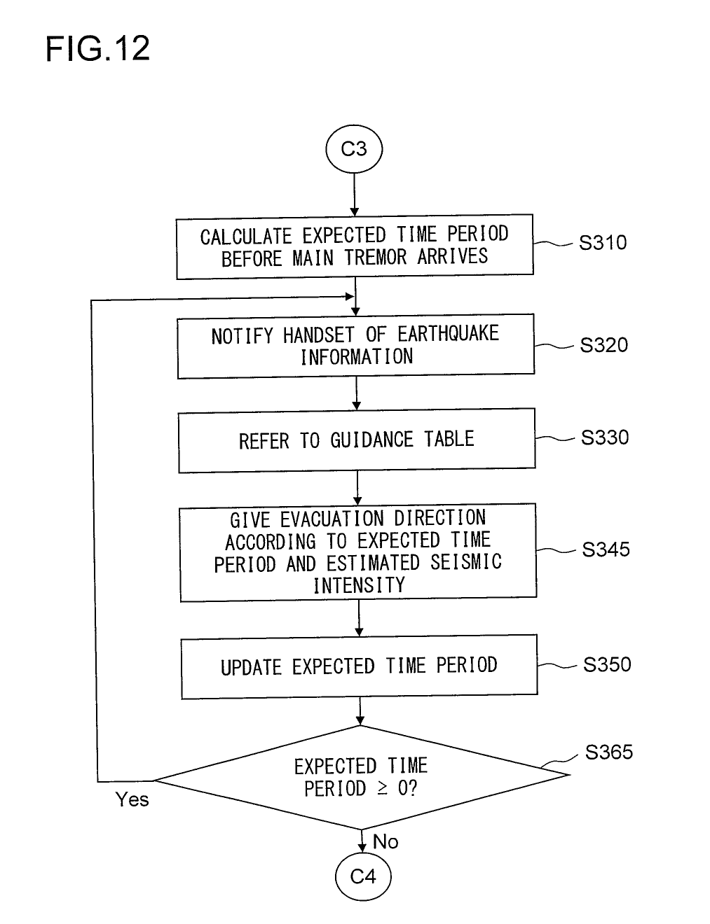

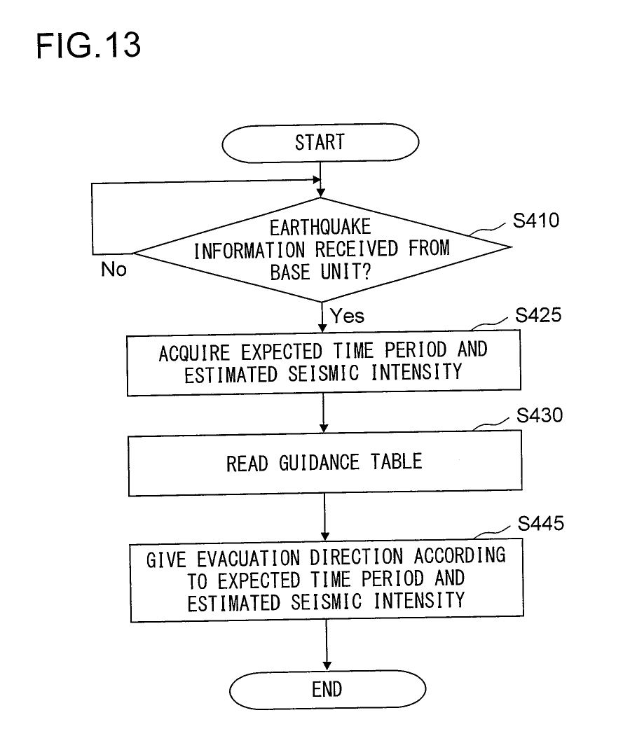

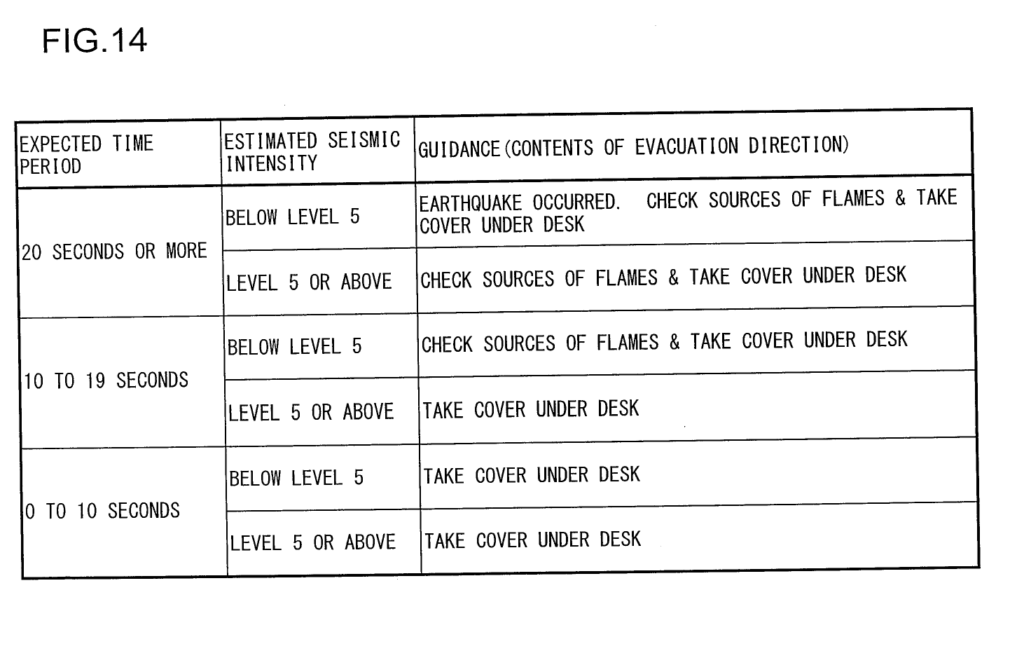

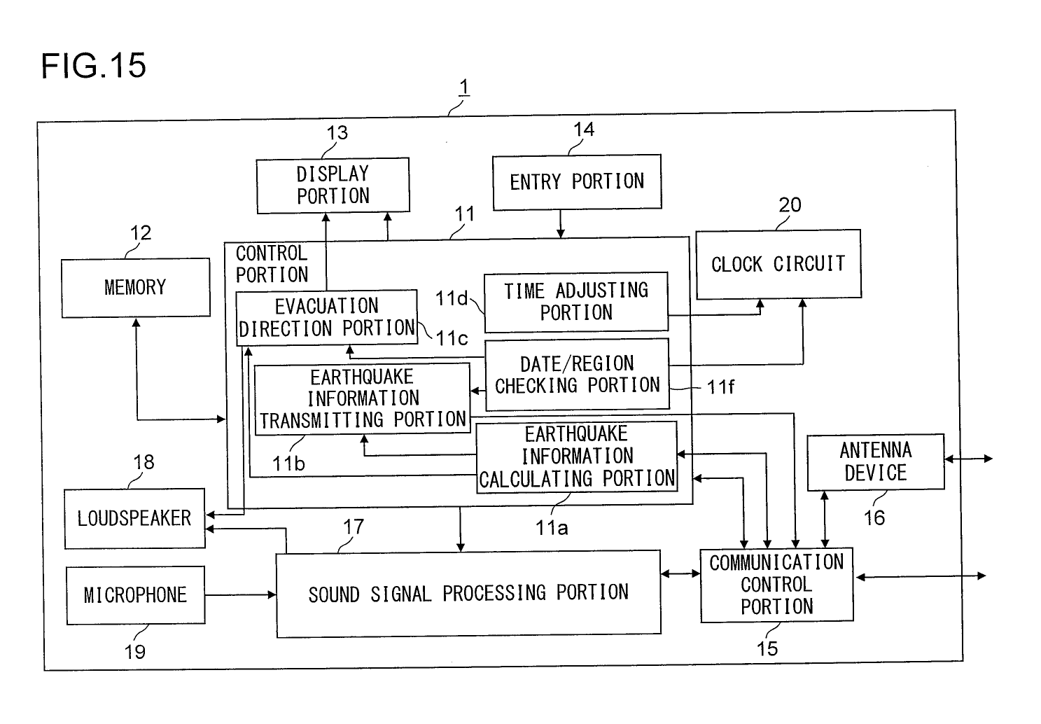

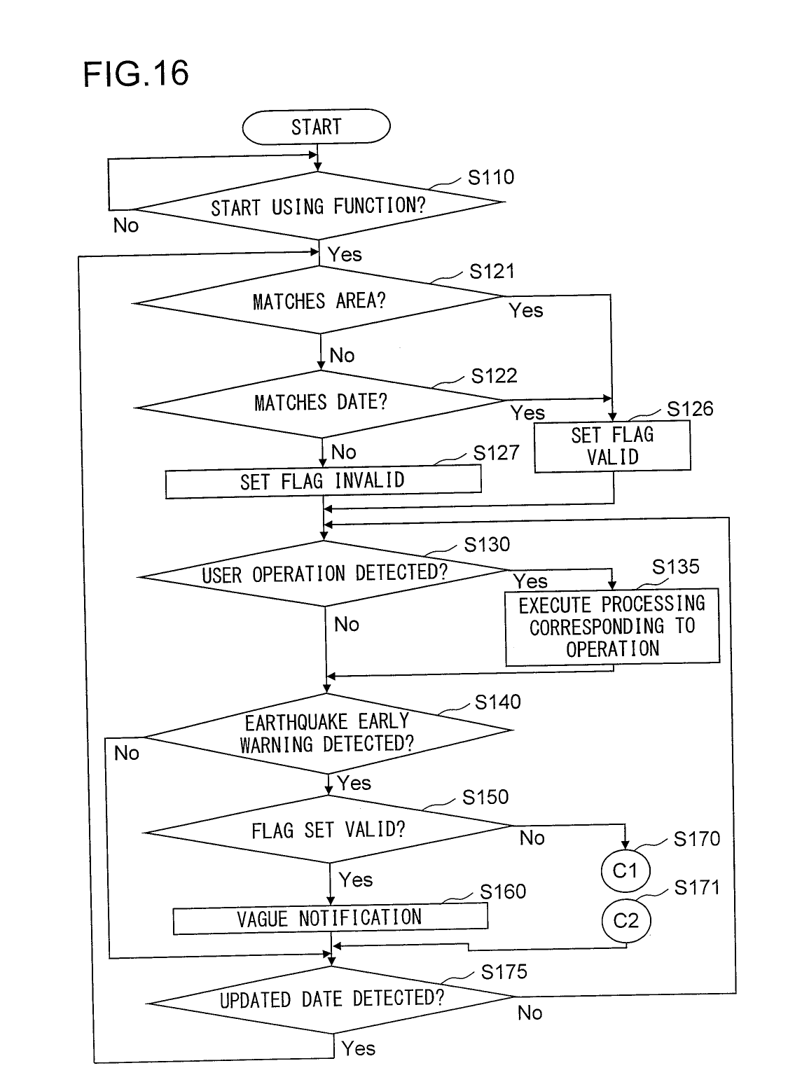

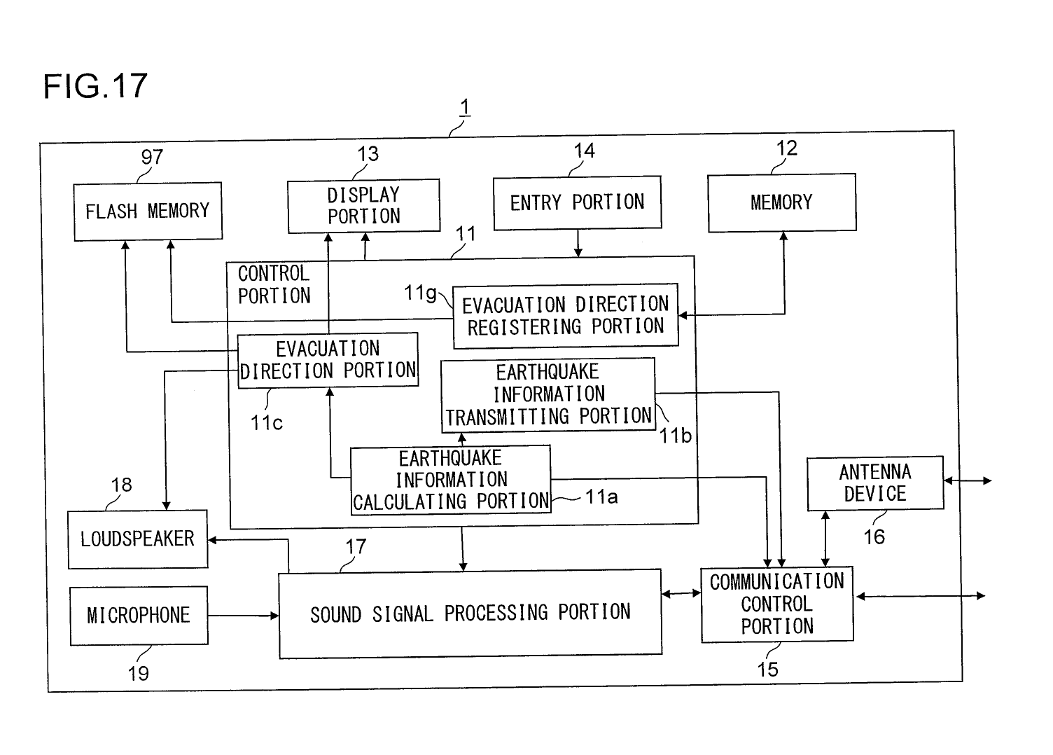

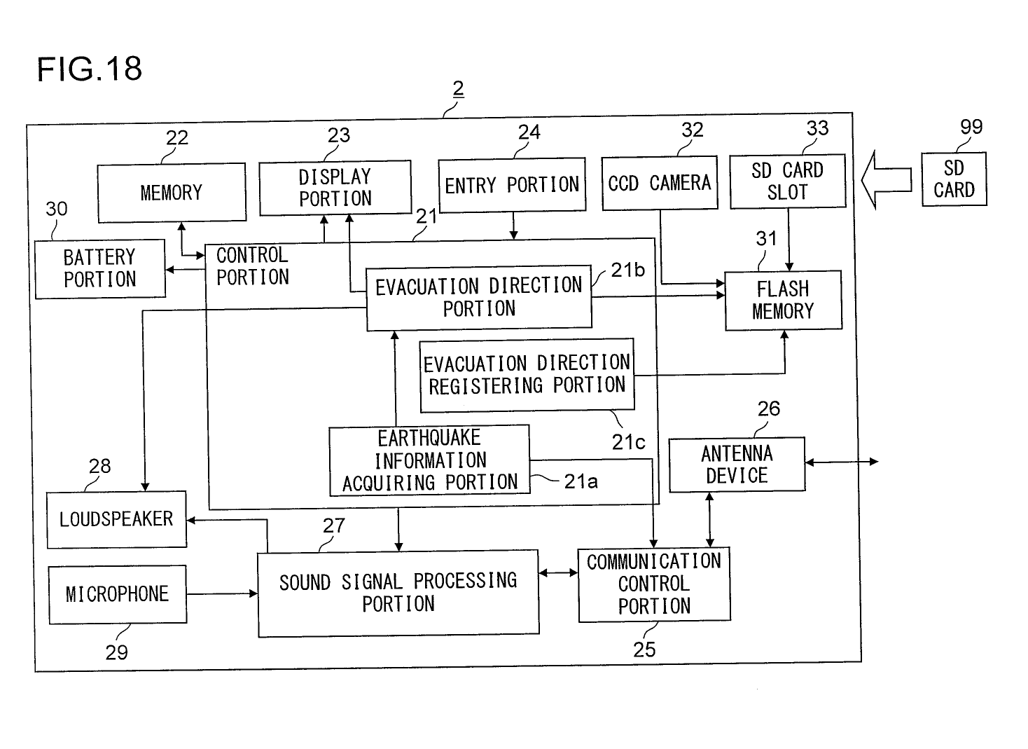

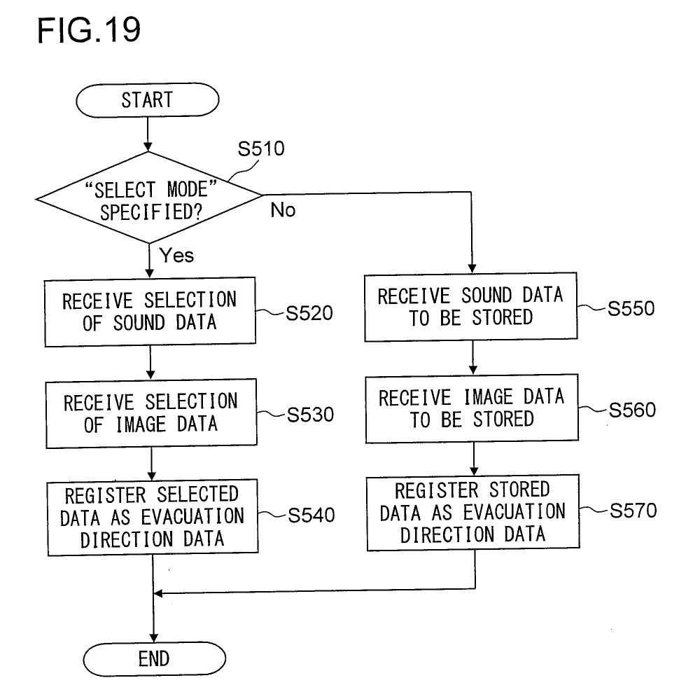

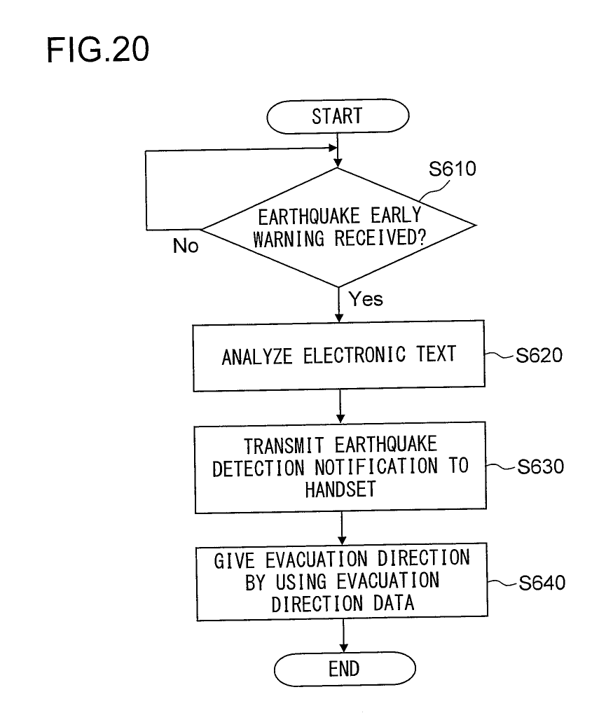

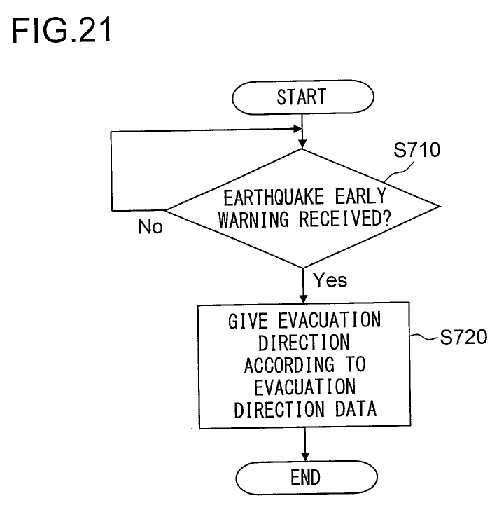

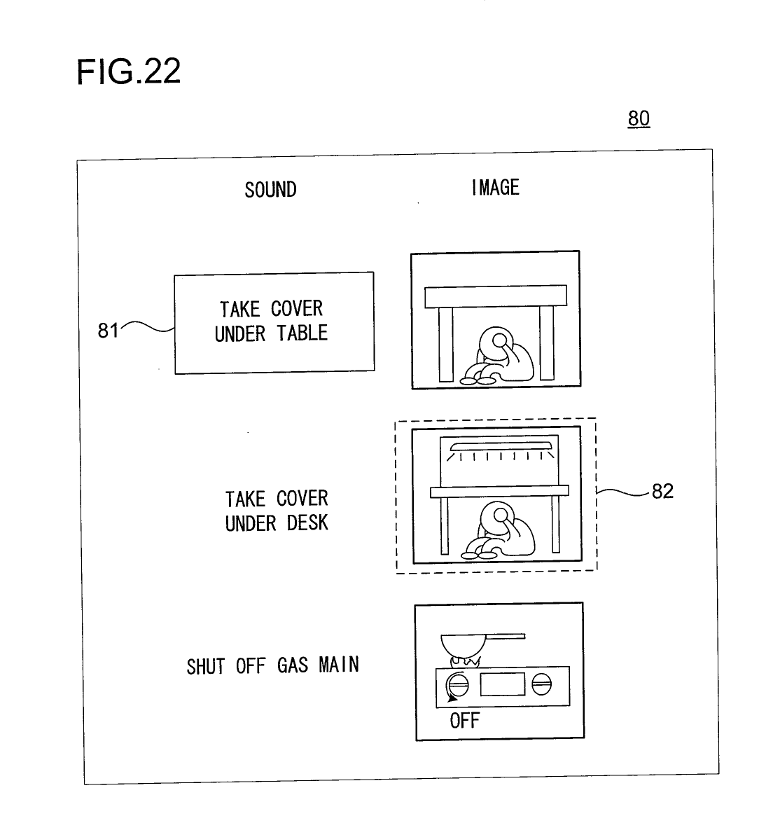

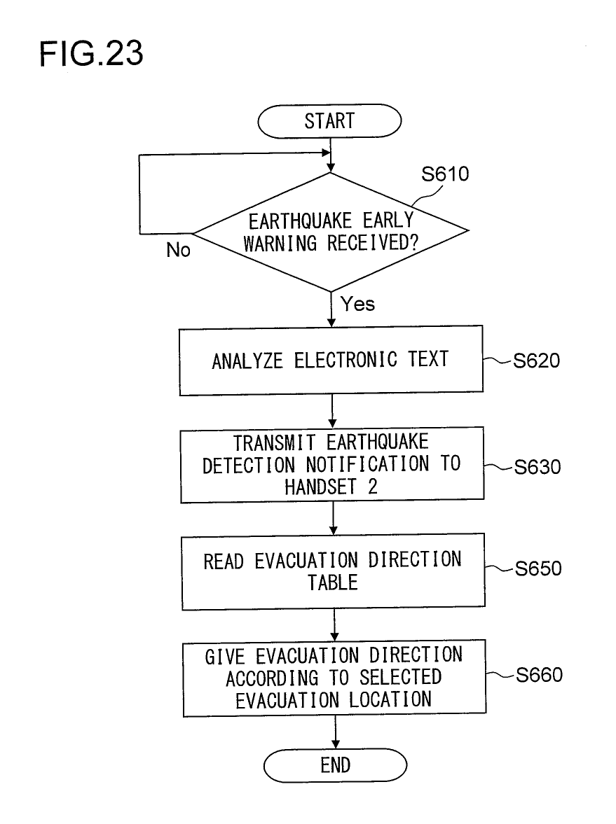

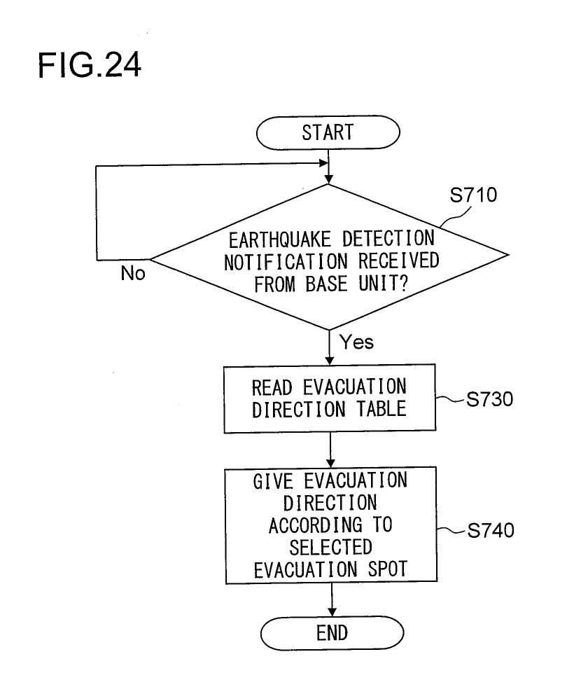

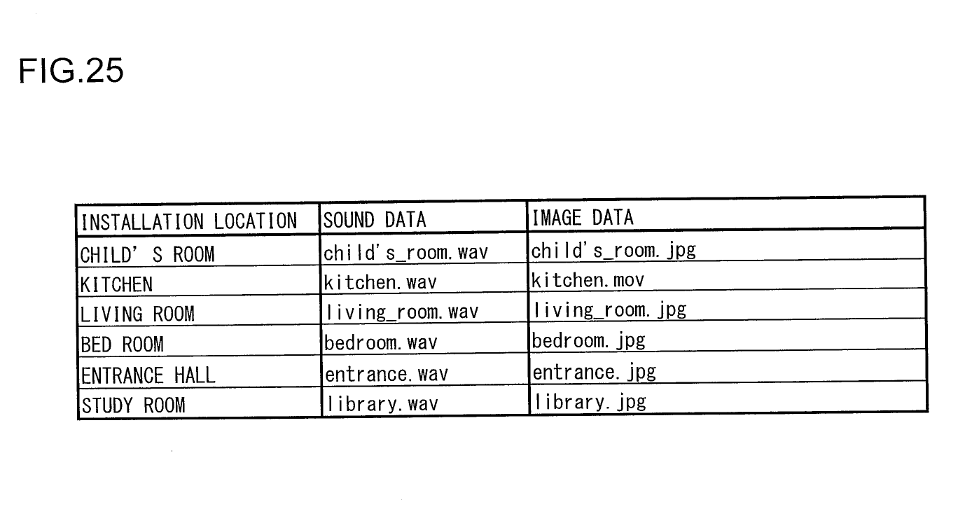

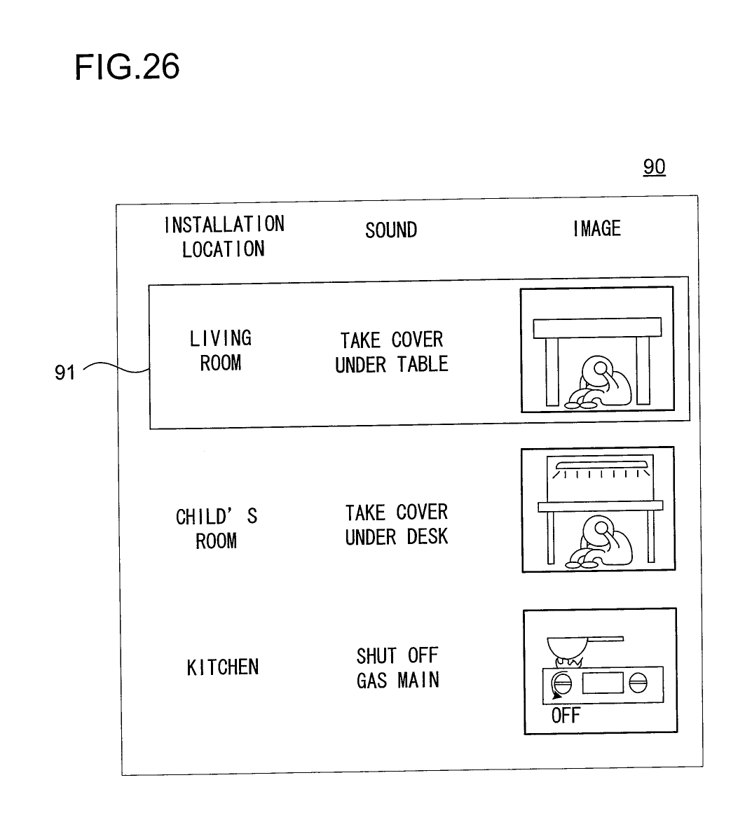

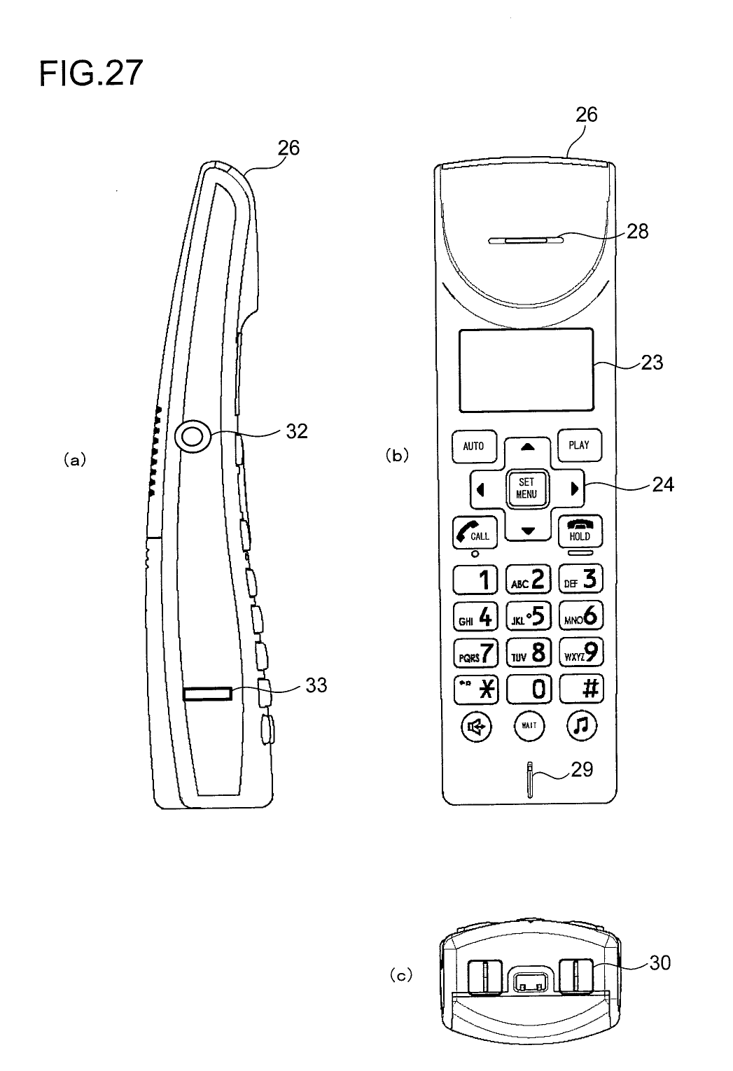

### BRIEF DESCRIPTION OF DRAWINGS

[FIG. 1] is a block diagram showing a structure of a telephone system according to the present invention.

[FIG. 2] is a block diagram showing a configuration of a base unit according to a first embodiment.

[FIG. 3] is a block diagram showing a configuration of a handset according to the first embodiment.

[FIG. 4] is a flow chart illustrating a flow of evacuation direction processing performed in the base unit according to the first embodiment.

[FIG. 5] is a flow chart illustrating a flow of evacuation direction processing performed in the base unit according to the first embodiment.

[FIG. 6] is a flow chart illustrating a flow of evacuation direction processing performed in the handset according to the first embodiment.

[FIG. 7] is a table diagram showing a structure of a message table according to the present invention.

[FIG. 8] is a table diagram showing a guidance table of a communication device according to the first embodiment.

[FIG. 9] is an external appearance diagram showing an external appearance of the handset according to the first embodiment.

[FIG. 10] is a block diagram showing a configuration of a base unit according to a second embodiment.

[FIG. 11] is a flow chart illustrating a flow of evacuation direction processing performed in the base unit according to the second embodiment.

[FIG. 12] is a flow chart illustrating a flow of evacuation direction processing performed in a handset according to the second embodiment.

[FIG. 13] is a flow chart illustrating a flow of evacuation direction processing performed in a handset according to the second embodiment.

[FIG. 14] is a table diagram showing a guidance table of a communication device according to the second embodiment.

[FIG. 15] is a block diagram showing a configuration of a base unit according to a third embodiment.

[FIG. 16] is a flow chart illustrating a flow of evacuation direction processing performed in the base unit according to the third embodiment.

[FIG. 17] is a block diagram showing a configuration of a base unit according to a fourth embodiment.

[FIG. 18] is a block diagram showing a configuration of a handset according to a fourth embodiment.

[FIG. 19] is a flow chart illustrating a flow of evacuation direction data registration processing according to the fourth embodiment.

[FIG. 20] is a flow chart illustrating a flow of evacuation direction processing performed in the base unit according to the fourth embodiment.

[FIG. 21] is a flow chart illustrating a flow of evacuation direction processing performed in the handset according to the fourth embodiment.

[FIG. 22] is a screen diagram showing an evacuation direction data selection screen according to the fourth embodiment.

[FIG. 23] is a flow chart illustrating a flow of evacuation direction processing performed in a base unit according to a fifth embodiment.

[FIG. 24] is a flow chart illustrating a flow of evacuation direction processing performed in a handset according to the fifth embodiment.

[FIG. 25] is a table diagram showing an evacuation direction table according to the fifth embodiment.

[FIG. 26] is a screen diagram showing an evacuation direction data selection screen according to the fifth embodiment.

[FIG. 27] is an external appearance diagram showing an external appearance of the handset according to the fifth embodiment.

### LIST OF REFERENCE SYMBOLS

1 Base unit (main communication device)
11a Earthquake information calculating portion
11b Earthquake information transmitting portion
11c Evacuation direction portion
11d Time adjusting portion
11e Temperature monitoring portion
11f Date/area checking portion
11g Evacuation direction registering portion
12 Memory (storage portion)
13 Display portion
15 Communication control portion (first communication portion)
16 Antenna device (wireless communication portion)
18 Loudspeaker (sound outputting portion)
20 Clock circuit (timekeeping portion)
21 Handset (subsidiary communication device)
21a Earthquake information acquiring portion
21b Evacuation direction portion
21c Evacuation direction registering portion
22 Memory (storage portion)
23 Display portion
25 Communication control portion (second communication portion)
26 Antenna device (wireless communication portion)
28 Loudspeaker (sound outputting portion)
31 Flash memory (storage portion)
97 Flash memory (storage portion)
98 Temperature sensor (temperature measuring portion)

### BEST MODE FOR CARRYING OUT THE INVENTION

Hereinafter, embodiments of the present invention will be described with reference to the accompanying drawings. The embodiments specifically described herein are illustrative only, and are thus not meant to limit how the present invention is implemented.

### Embodiment 1

### <1-1. Construction of Telephone System>

FIG. 1 is a block diagram showing a structure of a telephone system including a cordless telephone device (=communication device) of the present invention. The system is so constructed as to include: at least a base unit 1 (=main communication device); a plurality of handsets 2 (=subsidiary communication devices); a wired LAN 41; a wireless communications network 42; an IP telephone router 51; a broadband router 52; a gateway 53; an IP telephone network 61; the Internet 62; a PSTN network 63 (=Public Switched Telephone Network); and a subscriber's telephone device 71.

The cordless telephone device of the present invention can establish connection with an IP telephone network, and is applied to the base unit 1 and the plurality of handsets 2 (subsidiary device A 2a to subsidiary device C 2c). The base unit 1 is an IP telephone device that can perform voice communications via a telephone network by being connected to the wired LAN 41. The base unit 1 has a relay capability of relaying communication between the wired LAN 41 and the wireless communications network 42. Thus, the handsets 2, which will be described later, can be relayed by the base unit 1 to make calls via the IP telephone network 61 and the PSTN network 63. Moreover, the base unit 1 has a capability of receiving via the Internet 62, an earthquake early warning distributed by the Japan Meteorological Agency. Incidentally, an internal configuration of the base unit 1 will be described in detail later.

The handset 2 is a wireless calling device that is connected to the wireless communications network 42, which will be described later, to perform communications with the base unit 1, and that can perform thereby voice communications with other telephone devices via the IP telephone network 61 or the PSTN network. Incidentally, an internal configuration of the handset 2 will be described in detail later.

The wired LAN 41 is a local network in which the base unit 1, the IP telephone router 51, the broadband router 52, and the gateway 53, etc. are wiredly connected. By being connected to the wired LAN 41, the aforementioned individual devices can perform communications with one another. Examples of a physical means composing the wired LAN 41 include a 10 BASE-T (standardized as IEEE 802.3i), and 100 BASE-TX (standardized as IEEE 802.3u) that adopt a twist pair cable.

The wireless communications network 42 is a small-size communications network in which the base unit 1 and a plurality of handsets 2 are wirelessly connected. Specifically for example, they perform communications with each other by using an FHSS-WDCT (Frequency Hopping Spread Spectrum-Worldwide Digital Cordless Telephone)-compliant communication method that employs electric waves at a 2.4 GHz (gigahertz) frequency band, etc.

The IP telephone router 51 and the broadband router 52 are network relay devices for establishing mutual connection among a plurality of IP networks. Specifically, they analyze part of protocols of the Network Layer (third layer) and of the Transport Layer (fourth layer) in the OSI (Open Systems Interconnection) reference model to perform transfer. In this embodiment, the IP telephone router 51 serves to connect the two IP networks, namely the wired LAN 41 and the IP telephone network 61 together. The broadband router 52 serves to connect the two IP networks, namely the wired LAN 41 and the Internet 62 together.

The gateway 53 is a protocol converter for establishing mutual connection among networks having different protocol architectures. The gateway 53 connects, for example, the wired LAN 41 and the PSTN network 63 and, through signal conversion using a signaling protocol such as SIP, permit the two networks to perform communications between them.

The IP telephone network 61 is a communications network in which the VoIP (Voice over Internet Protocol) technology is applied to part or whole of a telephone network, and in which, as a communications line used, a so-called broadband line, such as FTTH (Fiber To The Home) or ADSL (Asymmetric Digital Subscriber Line), is employed. Incidentally, the VoIP is a technology with which speech is compressed, and converted into packets by various coding methods to be transferred in real time over the IP network. With this, it is possible to provide not only voice call services but also videophone services by which images are transmitted and received, through the IP network 61.

The Internet 62 is a wide area communications network which is constructed by mutually connecting communication-protocol-based networks. Different computer networks varying in size are joined with one another to construct the international communications network. As the communication protocol, mainly the TCP/IP is adopted as a standard protocol.

The PSTN network 63 is a general subscriber's telephone line network. The network has telephone devices connected at the ends, and is used to perform voice communications by establishing connection with a communication party by a line switching method. The subscriber's telephone device 71 is a telephone device with which a subscriber engages in voice conversation with another subscriber's telephone device or IP telephone device, by using the PSTN network 63.

### <1-2. Internal Configuration of Base Unit>

FIG. 2 is a block diagram showing the internal configuration of the base unit 1 according to the first embodiment of the present invention. The base unit 1 is so constructed as to include: at least, a control portion 11; a memory 12 (=storage portion); a display portion 13; an entry portion 14; a communication control portion 15 (=first communication portion); an antenna device 16 (=wireless communication portion); a sound signal processing portion 17; a loudspeaker 18 (=sound outputting portion); a microphone 19; and a clock circuit 20 (=timekeeping portion).

The control portion 11 is a central processing unit for performing comprehensive control of communication control processing (including transmission and reception of sound data, making of outgoing calls, and detection of incoming calls). The control portion 11 is provided with: as functional blocks implemented by executing programs on an arithmetic operation unit provided in the control portion 11, an earthquake information calculating portion 11a, an earthquake information transmitting portion 11b, an evacuation direction portion 11c, and a time adjusting portion 11d.

The earthquake information calculating portion 11a receives an earthquake early warning from the Internet 62 by using the communication control portion 15. The earthquake early warning includes an earthquake detected time, an earthquake identification number, an epicenter name code, latitude and longitude of a focus, the depth of that focus, a magnitude, a maximum estimated seismic intensity, accuracy of data (in connection with a system, a processing method, etc. used in a measurement), etc. The estimated seismic intensity and the expected time period before the main tremor arrives included in the earthquake early warning are rough estimations; thus it is necessary to calculate more specific estimated seismic intensity, etc. by a receiver side for each area.

Processing for the calculation is largely divided into two, namely single-station processing and multiple-station processing. The single-station processing is local, spot-focused measurement processing, such as P-wave detection and level method, which is performed assuming that the earthquake has occurred close to the station. The multiple-station processing is for calculating the estimated seismic intensity and the expected arrival time of the main tremor on a specific location, using a plurality of results of the single-station processing. Typical methods for the processing include a territory method and a grid search method.

The earthquake information calculating portion 11a performs the multiple-station processing based on a result of the single-station processing included in the earthquake early warning, and latitude-longitude information recorded in the memory 12. Specifically for example, first, from a plurality of results of the single-station processing, three elements (epicenter: X, Y; time: T; magnitude: M) are obtained. Subsequently obtained are an epicentral distance at a specific location (distance from the epicenter X, Y to the specific location X0, Y0) and, from the magnitude M of the earthquake, the radius of an area in which motion is felt. Incidentally, the specific location here refers to latitude and longitude at which the base unit 1 is located.

The earthquake information calculating portion 11a obtains a standard intensity Sr at the specific location, from the epicentral distance D, the magnitude M of the earthquake, and the depth H of the focus. Subsequently, an amplitude coefficient A for the specific location is obtained based on its geological conditions, etc. and, using the standard intensity Sr and the amplitude coefficient A, the estimated intensity of the main tremor (S wave), the maximum velocity, maximum acceleration, maximum displacement, expected arrival time, etc. are obtained. Incidentally, the foregoing is not meant to limit the calculation method employed by the earthquake information calculating portion 11a, and appropriate changes can be made according to the kind of application and data contents included in the earthquake early warning.

Moreover, the earthquake information calculating portion 11a calculates from the expected arrival time of the main tremor and current time that is notified by the clock circuit 20, the expected time period before the main tremor arrives, namely an allowed time period during which users can take evacuation actions. A result from the calculation is fed to the next earthquake information transmitting portion 11b and to the evacuation direction portion 11c. The earthquake information calculating portion 11a performs the above-described calculation processing every time a new earthquake early warning is received.

The earthquake information transmitting portion 11b is fed with the calculation result from the earthquake information calculating portion 11a, and then transmits to the handsets 2 by using the communication control portion 15, earthquake information including the expected arrival time of the main tremor, estimated seismic intensity, and expected time period before the main tremor arrives so calculated.

The evacuation direction portion 11c is fed with the expected time period before the main tremor arrives, from the earthquake information calculating portion 11a, reads a guidance table (=association table) stored in the memory 12. Based on the guidance table so read, the evacuation direction portion 11c then finds a guidance (contents of an evacuation direction) corresponding to the current expected time period. After that, a voice message and a text image are outputted by using the display portion 13 and the loudspeaker 18. Thus, it is possible to give an evacuation direction according to the expected time period to the users.

The evacuation direction portion 11c updates the expected time period at predetermined time intervals, for example every second. For each updating, the evacuation direction portion 11c finds the guidance corresponding to the expected time period so updated, by using the guidance table. Incidentally, the guidance table, and examples of the images and sounds outputted from the display portion 13 and loudspeaker 18 will be described in detail later.

The evacuation direction portion 11c, in its outputting processing, refers to an adjustment failure flag; if the flag is invalid, the evacuation direction portion 11c makes a normal notification and, if the flag is valid, makes an vague notification. The vague notification will be described in detail later.

By using the communication control portion 15, the time adjusting portion 11d performs communication with an external NTP server at predetermined time intervals, for example every week or every month. Based on time information acquired from the NTP server, the time adjustment portion 11d adjusts time of the clock circuit 20. If failing to acquire the time information from the NTP server due to a communication error, etc., the time adjusting portion 11d sets the adjustment failure flag to valid. The time adjusting portion 11d also sets the adjustment failure flag to valid if failing to adjust the time for the reason that the clock circuit 20 is disabled, etc. Incidentally, the adjusting failure flag is stored in a storage portion such as the memory 12. The flag may be stored by using a register or the like.

The memory 12 is a medium in which various kinds of data retained by the base unit 1 are temporarily stored, and is composed of, for example, a writable RAM (Random Access Memory) or the like. The memory 12 serves as a buffer memory for temporarily storing data to be processed in each communication control processing, instruction commands received from the user, etc. Moreover, the memory 12 serves to store latitude-longitude information for calculating the expected arrival time of the main tremor.

The display portion 13 displays to the user, various information that the base unit 1 retains (e.g., a telephone number of a caller when an incoming call is received). The display portion 13 adopts a display device, such as a liquid crystal panel, having a small size and power consumption. The entry portion 14 is one with which the user performs different kinds of operations (e.g., entering a telephone number of a partner to which the user is making a call, etc.) for communication by using the base unit 1. Generally, the entry portion 14 is composed of a plurality of operation buttons, such as numerical buttons and a redial button.

The communication control portion 15 is a communication interface for connecting the base unit 1 to the wired LAN 41. The communication control portion 15 can perform processing on incoming calls, outgoing calls, etc. in the IP telephone system by establishing communication with a call control server (unillustrated) which is connected to the wired LAN 41. Moreover, the communication control portion 15 performs control of wireless communication via the wireless communications network 42 by the antenna device 16.

The antenna device 16 is a wireless communication device for transmitting and receiving wireless communication radio waves to and from the handsets 2. The antenna device 16 performs wireless communication according to a communication method, etc. that comply with a given communication standard, such as the FHSS-WDCT (Frequency Hopping Spread Spectrum-Worldwide Digital Cordless Telephone). Thus, the base unit can perform voice and data communications with the handsets 2.

The sound signal processing portion 17 performs decoding processing on sound data fed by the communication control portion 15, and then feeds the result to the loudspeaker 18 in the form of a sound signal. The sound signal processing portion 17 performs encoding processing on a sound signal fed by the microphone 19 to generate the sound data, and then feeds it to the communication control portion 15. Thus, the sound data is transmitted to another telephone device connected via the wired LAN 41, the wireless communications network 42, the IP telephone network 61, or the like.

The clock circuit 20 is a circuit for keeping the current time, and keeps the time by using a crystal oscillator producing, for example, a predetermined frequency oscillation. Moreover, the clock circuit 20 can manage not only time information but also calendar information related to a calendar, such as the current month, day, and day of the week.

### <1-3. Internal Configuration of Handset>

FIG. 3 is a block diagram showing an internal portion of the handset 2 according to the first embodiment of the present invention. The handset 2 is so configured as to include: at least a control portion 21; a memory 22 (=storage portion); a display portion 23; an entry portion 24; a communication control portion 25 (=second communication portion); an antenna device 26 (=wireless communication portion); a sound signal processing portion 27; a loudspeaker 28 (=sound outputting portion); a microphone 29; and a battery portion 30.

The control portion 21 is a central processing unit that performs comprehensive control of communication control processing (including transmission and reception of sound data, making of outgoing calls, and detection of incoming calls). The control portion 21, as a functional block implemented by executing a program on an arithmetic operation unit provided in the control portion 21, is provided with an earthquake information acquiring portion 21a and an evacuation direction portion 21b.

The earthquake information acquiring portion 21a extracts earthquake information related to the earthquake early warning from among different information received from the base unit 1. The earthquake information acquiring portion 21a then feeds each value contained in the earthquake information so extracted, to the evacuation direction portion 21b.

The evacuation direction portion 21b is fed with the earthquake information from the earthquake information acquiring portion 21a, and then outputs an evacuation direction voice or an evacuation direction image based on the earthquake information. Incidentally, for this outputting, data stored in advance in the memory 22 is used or data contained in an electronic text received from the base unit 1 is used.

In a case where the data inside the memory 22 is used, data for making a normal notification and data for making a vague notification are stored in advance in the memory 22. The electronic text transmitted by the evacuation direction portion 11c of the base unit contains instruction data indicating which type of the data is to be used. Based on the instruction data, the evacuation direction portion 21b determines which type of the data to bee used to give an evacuation direction.

To make the normal notification, the evacuation direction portion 21b reads the guidance table stored in the memory 22. The evacuation direction portion 21b then finds the guidance corresponding to the current expected time period from the guidance table so read. The evacuation direction portion 21b outputs a voice message or a text image corresponding to the guidance so found, by using the display portion 23 and the loudspeaker 28. Thus, it is possible to give an evacuation direction to the user according to the expected time period.

The evacuation direction portion 21b may be provided with a capability of updating the expected time period at predetermined time intervals, for example, every second. In that case, the evacuation direction portion 21b, every time updating the expected time period, finds the guidance corresponding to the expected time period so updated, from the guidance table, and then gives an evacuation direction.

The memory 22 is a medium in which various kinds of data retained by the handset 2 is temporarily stored, and is composed of, for example, a writable RAM (Random Access Memory) or the like. The memory 22 serves as a buffer memory for temporarily storing data to be processed in each communication control processing, instruction commands received from the user, etc.

The display portion 23 displays to the user, various information that the base unit 1 retains (e.g., a telephone number of a caller when an incoming call is received). The display portion 23 adopts a display device, such as a liquid crystal panel, having a small size and power consumption. The entry portion 24 is one with which the user performs different kinds of operations (e.g., entering a telephone number of a partner to which the user is making a call, etc.) for communication by using the base unit 1. Generally, the entry portion 14 is composed of a plurality of operation buttons, such as numerical buttons and a redial button.

The communication control portion 25 performs control of wireless communication by the antenna device 26. Thus, the handset 2 can perform communication with the base unit 1 that has established connection with the wireless communications network 42. Through relay by the base unit 1, the handset 2 can perform processing on incoming calls, outgoing calls, etc. via the PSTN network 63.

The antenna device 26 to the microphone 29 here have the same configuration as the antenna device 16 to the microphone 19 of the base unit 1; thus no overlapping description on them is given. The battery portion 30 is fed with electric power by an external power supply (unillustrated), and temporarily stores electric power. A rechargeable-type alkaline cell, a lithium-ion battery, or the like is employed here among others.

### <1-4. External Design of Handset>

FIG. 9 is an external appearance diagram showing an external design of the handset 2 according to the first embodiment of the present invention. FIG. 9(a) is an external appearance diagram showing the handset 2 as seen from its side surface, FIG. 9(b) is an external appearance diagram showing the handset 2 as seen from its front surface, and FIG. 9(c) is an external appearance diagram showing the handset 2 as seen from its bottom surface.

As shown in FIG. 9, the handset 2 is provided with, at its front surface, the display portion 23, the entry portion 24, the antenna device 26, the speaker 28, and the microphone 29. The handset 2 is provided with, in its bottom portion, the battery portion 30. The entry portion 24 provided with a set of plural operation buttons is located below the display portion 23 including the liquid crystal panel.

### <1-5. Structure of Guidance Table>

FIG. 8 is a table diagram showing a guidance table in which the expected time period and the guidance corresponding to it are associated with each other. As shown in FIGS. 8(a) and 8(b), the guidance tables are composed of two columns, namely an “EXPECTED TIME PERIOD” column and a “GUIDANCE” column from the left in this order.

The “EXPECTED TIME PERIOD” column indicates a plurality of ranges into which the expected time period before the main tremor arrives is categorized based on predetermined values. For example, in the example shown in FIG. 8(a), with reference to the expected time period of 10 seconds, two ranges, namely “10 SECONDS OR MORE” and “LESS THAN 10 SECONDS” are set. In the example shown in FIG. 8(b), with reference to the expected timer period of 10 seconds and the expected time period of 20 seconds, three ranges, namely “20 SECONDS OR MORE,” “10 TO 19 SECONDS,” and “0 TO 9 SECONDS” are set.

The “GUIDANCE” column indicates a guidance (=contents of the evacuation direction) corresponding to the ranges shown in the “EXPECTED TIME PERIOD” column. In the example shown in FIG. 8(a), two guidances are contained; in the example shown in FIG. 8(b), three guidances are contained. For example, according to FIG. 8(a), if the expected time period is 15 seconds, the guidance in the row indexed by “10 SECONDS OR MORE” in the “EXPECTED TIME PERIOD” column, namely “CHECK SOURCES OF FLAMES & TAKE COVER UNDER DESK” is used.

Based on that guidance, the evacuation direction portions 11c and 21b, for example, display the contents of the guidance described above in the form of an electric text image or output it in the form of synthesized voice. Instead, pictograms may be displayed that indicate one should check sources of flames, and that indicates one should take cover under a desk. Which of the guidance tables shown in FIG. 8(a) and FIG. 8(b) to be used can be changed appropriately according to the application. The “EXPECTED TIME PERIOD” and “GUIDANCE” columns may be configured such that some or all of the values contained in each column can be varied by using the operation portion 13 or the operation portion 23.

### <1-6. Evacuation Direction Processing>

Next, evacuation direction processing performed by using the base unit 1 and the handsets 2 at the time of receiving an earthquake early warning will be described with reference to the block diagrams in FIGS. 1 to 3, the flow charts in FIGS. 4 to 6, and the tables in FIGS. 7 and 8.

FIG. 4 is a flow of processing performed in the base unit 1 being in a stand-by state to receive the earthquake early warning. The flow of processing shown in FIG. 4 can be started at any time when the power supply of the base unit 1 is activated, and is able to perform communication with the Internet 62. After the processing is started, the control portion 11 judges, in step S110, whether or not an instruction to start using a vague notification function of the present invention has been received from the user. That start instruction is issued, for example, at a time when a predetermined setting button incorporated in the entry portion 14 is pressed, or at other times.

If it is judged that the start instruction is not received, the flow proceeds to step S110 again, and the start instruction continues to be monitored until it is detected. If the start instruction is received, the time adjusting portion 11d starts a timer for counting access timing with which access is made to the NTP server, in step S120. The timer employs a software clock, which is realized by executing a predetermined program by the control portion 11, and is preferably provided separately from the clock circuit 20.

Subsequently, the control portion 11 judges whether or not any of instructions to execute processing among different kinds of communication processing is detected in step S130. Specifically for example, the above-described execute instructions are issued in correspondence with an instruction to make an outgoing call given by the user operation using the entry portion 14, incoming call detection by the communication control portion 15, etc. On receiving the execute instruction, the control portion 11 performs the corresponding communication processing according to the execute instruction, in step S135, and the flow then proceeds to step S140. Incidentally, the communication processing is the same as the conventional technology; thus no overlapping description on it is given.

If no instruction to execute the communication processing is detected, the flow proceeds directly to step S140. In step S140, the earthquake information calculating portion 11a judges whether or not the communication control portion 15 has received the earthquake early warning. If the reception is detected, the earthquake information calculating portion 11a performs arithmetic operations by using various parameters included in the earthquake early warning, and the latitude-longitude information stored in the memory 12. Thus the estimated seismic intensity and the expected arrival time of the main tremor at the area where the base unit 1 is installed are calculated.

Subsequently in step S150, the evacuation direction portion 11c judges whether or not the adjusting failure flag of the clock circuit 20 is valid. If the adjusting failure flag is valid, the evacuation direction portion 11c makes the vague notification in step S160.

A specific example of the vague notification will be described with reference to a table diagram in FIG. 7. The evacuation direction portion 11c determines an evacuation direction sound based on the estimated seismic intensity calculated by the earthquake information calculating portion 11a, and the message table (FIG. 7) stored in the memory 12. For example, if the estimated seismic intensity is level 4, the evacuation direction sound “EARTHQUAKE WITH FAIRLY STRONG MOTION WILL STRIKE” is outputted from the loudspeaker 18.

Moreover, instead of using such a message table as described above, a message may be simply outputted that notifies of the expected seismic intensity alone. For example, a message such as “EARTHQUAKE AT LEVEL N WILL STRIKE SOON” (where N is a variable that indicates a level of the seismic intensity) is used. The sound signal processing portion 15 is fed with an instruction to vary the value of N according to the expected seismic intensity whereby the evacuation direction sound according to the expected seismic intensity can be outputted from the loudspeaker 18.

Instead of using a message according to the message table or the expected seismic intensity, a fixed message may be used. For example, like “EARTHQUAKE WILL STRIKE SOON,” a message including the minimum evacuation direction irrespective of the expected arrival time and the estimated seismic intensity is used. Thus, although the amount of information included in the evacuation direction is reduced, the evacuation instruction can be made simply and immediately.

In each of the examples described above, a notification is made of the expected seismic intensity; on the other hand, no notification is made of either of the expected arrival time of the main tremor and the expected time period before the expected arrival time reaches. By giving an evacuation direction using vague expressions in connection with the time and the time period in this way, it is possible to give an appropriate evacuation direction to the user even if the time accuracy of the clock circuit 20 cannot be assured or even if the clock circuit 20 is disabled.

The evacuation direction portion 11c not only outputs the evacuation direction voice from the loudspeaker 19, but also displays an evacuation direction image on the display portion 23. Moreover, by using the communication control portion 15, the evacuation direction portion 11c transmits earthquake information and information indicating whether or not to make a vague notification, to the handset 2. On receiving them, the earthquake information acquiring portion 21a and the evacuation direction portion 21b of the handset 2 make either of the normal notification and the vague notification based on the information received. Incidentally, the vague notification made by the handset 2 if the flow proceeds to step S160 is the same as in the base unit 1 in detail; thus no overlapping description on it is given here. The notification made by the handset 2 if the flow proceeds to step S170 (FIG. 6) will be described in detail later.

If the adjusting failure flag is invalid in step S150, a transition is made to a flow of processing shown in FIG. 5, in step S170. A connector symbol C1 shown in connection with step S170 and a connector symbol C2 shown in connection with step S171 in FIG. 4 correspond to a connector symbol C1 and a connector symbol C2 shown in FIG. 5, and connect the flows of the processing with each other. Accordingly, if the flow of the processing shown in FIG. 5 comes to an end, it moves onto the connector symbol C2 shown in connection with step S171. Incidentally, the details on FIG. 5 will be described later.

If the notification processing is completed in this way in step S160 or step S171, the flow proceeds to step S130 again. The description is continued with reference back to step 140. In step S140, if it is judged that no earthquake early warning has been detected, the evacuation direction portion 11c judges, in step S180, whether or not the timer started in step S120 has expired.

If the timer has not expired yet, the flow proceeds to step S130 again. If the timer has expired, the timer is initialized in step S190. Subsequently, the time adjusting portion 11d checks whether or not the clock circuit 20 is operating correctly. The term “operating correctly” would mean that, for example, a response is correctly returned with respect to a request to acquire the time information made to the clock circuit 20. Accordingly, it is impossible to check whether or not an error arises in the time information.

If it is judged that the clock circuit 20 is not operating correctly, the flow proceeds to step S230, which will be described later. If it is judged that it is operating correctly, the time adjusting portion 11d makes access to the external NTP server by using the communication portion 15, in step S210. Subsequently in step S220, whether or not the communication has been established with the NTP server and the time acquisition processing has come to a normal end is judged.

If the processing does not come to a normal end, the time adjusting portion 11d sets the adjusting failure flag stored in the memory 12 to valid in step S230, and the flow proceeds to step S120. If the processing comes to a normal end, the time of the clock circuit 20 is corrected based on the result of acquisition, in step S240. After the adjusting failure flag is set to invalid in step S250, the flow proceeds to step S120 again.

The control portion 11 receives an instruction to stop executing the evacuation direction processing of the present invention through the user operation, etc. by the entry portion 24 whereby it is possible to terminate at any time, the above-described flows of the processing performed in sequence. As a result, at the time of receiving the earthquake early warning, simply the notification processing shown in FIG. 5 is executed.

FIG. 5 shows a flow of processing along which the base unit 1 gives the evacuation direction according to the expected time period before the main tremor arrives; the flow is started if the processing proceeds to step S170 in FIG. 4. After this processing is started, the earthquake information calculating portion 11a calculates the expected time period before the main tremor arrives, in step S310. For example, the current time is acquired from the clock circuit 20, and the expected time period is then obtained by calculating a difference between the current time and the expected arrival time of the main tremor obtained in step S140 in FIG. 4.

Subsequently in step S320, by using the communication portion 15 and the antenna device 16, the earthquake information transmitting portion 11b transmits to one or the plurality of handsets 2, the earthquake information including the estimated seismic intensity, the expected arrival time of the main tremor, and the expected timer period before the main tremor arrives that have been calculated by the earthquake information calculating portion 11a.

Subsequently in step S330, the evacuation direction portion 11c reads a guidance table shown in FIG. 8 from the memory 12, and refers to it. In step S340, from the value of the expected time period and the guidance table, the guidance corresponding to the current expected time period is found. Then the sound message, text message, pictogram or the like corresponding to that guidance is outputted by using the display portion 13 and the loudspeaker 18.

For example, if the expected time period is 15 seconds, and the guidance table is so configured as to have the contents shown in FIG. 8(a), the sound and text messages corresponding to the guidance “CHECK SOURCES OF FLAMES & TAKE COVER UNDER DESK” are outputted. When the display portion 13 is provided with a capability of displaying pictograms, those signifying that one should check sources of flames and that one should take cover under a desk are displayed.

Subsequently in step S350, the evacuation direction portion 11c updates the expected time period, at a time when a predetermined time has elapsed. For example, every time a second elapses, the evacuation direction portion 11c updates the expected time period to decrement it by one second. When the current time passes the expected arrival time, the value of the expected timer period is negative. In step S360, whether or not the current expected time period is equal to or more than 0 is judged. If it is equal to or more than 0, the flow proceeds to step S160 to output the evacuation direction corresponding to the expected time period.

Meanwhile, if it is necessary to change the contents of the evacuation direction, for example if the expected time period is changed from 10 seconds or more to 10 seconds or less, the evacuation direction having been given so far is suspended, and a new evacuation direction is outputted. Thus, even if the evacuation direction is being given in correspondence with the guidance “CHECK SOURCES OF FLAMES & TAKE COVER UNDER DESK,” it is forcefully switched to the evacuation direction corresponding to the guidance “TAKE COVER UNDER DESK.”

In step S360, if the current expected time period is less than 0, namely negative, the current processing is terminated, and the flow proceeds to step S171 in FIG. 4. For that, the evacuation direction being outputted may be stopped or the main power supply of the communication device may be turned off.

Next, a flow of processing performed in the handset 2 if the processing in the base unit 1 proceeds to step S170 in FIG. 4 will be described with reference to a flow chart in FIG. 6. The flow of the processing shown in FIG. 6 can be started at any time when the handset 2 is in the stand-by state, and is waiting for an earthquake early warning to be transmitted from the base unit 1 in step S320 in FIG. 5.

After the processing is started, the earthquake information acquiring portion 21a judges, in step S410, whether or not to have received earthquake information about the earthquake occurred, from the base unit 1 through the antenna device 26.

If it is judged that no earthquake information is received, the flow proceeds to step S410 again, and the earthquake information is continued to be monitored until it is detected. If the earthquake information is detected to have been received, the earthquake information acquiring portion 21a extracts the expected time period before the main tremor arrives from among earthquake information received from the base unit 1, in step S420. The expected time period so extracted is fed to the evacuation direction portion 21b.

Subsequently in step S430, the evacuation direction portion 21b reads the guidance table shown in FIG. 8 from the memory 22, and refers to it. In step S440, from the value of the expected time period and the guidance table, the guidance corresponding to the current expected time period is found. Then the sound message, text message, pictogram or the like corresponding to that guidance is outputted.

Subsequently in step S450, the evacuation direction portion 21b updates the expected time period, at a time when a predetermined time has elapsed. In step S460, whether or not the current expected time period is equal to or more than 0 is judged. If it is equal to or more than 0, the flow proceeds to step S440 again to output the evacuation direction according to the expected time period.

In step S460, if the current expected time period is less than 0, namely negative, the current processing is terminated. For that, the evacuation direction being outputted may be stopped or the main power supply of the communication device may be turned off.

As described above, according to this embodiment, even if an earthquake early warning is received under circumstances where the accuracy of the clock circuit 20 cannot be assured because establishing communication with the NTP server is impossible or where the clock circuit 20 is disabled, it is possible to give an appropriate evacuation direction to a user.

Next, a second embodiment of the present invention will be described with reference to the accompanying drawings.

### Embodiment 2

### <2-1. Construction of Telephone System>

This embodiment employs the same construction as in Embodiment 1; thus no overlapping description on it is given here.

### <2-2. Internal Configuration of Base Unit>

The base unit 1 in this embodiment is provided with: the control portion 11 to the clock circuit 20 in Embodiment 1, and a temperature sensor 98 (=temperature measuring portion). Moreover, the base unit 1 is provided with, as a functional block realized by executing a predetermined program by the control portion 11, a temperature monitoring portion 11e. Functions of the earthquake information transmitting portion 11b and the evacuation direction portion 11c are partially different from those in Embodiment 1.

The temperature sensor 98 is a measurement instrument for measuring an ambient temperature outside the base unit 1, an internal temperature and a substrate temperature of the base unit 1, a CPU temperature, etc. The temperature sensor 98 is provided with a temperature sensor element such as a thermistor. The thermistor is a temperature sensor element formed out of an oxide semiconductor material whose electric resistance value varies with temperature, and that adopts a metal oxide (Mn, Co, Ni) or a silicon single-crystal, thin film (Ge, SiC) among others.

The temperature monitoring portion 11e monitors a temperature measured by the temperature sensor 98 and if the temperature increases or decreases to fall out of a predetermined range, a temperature change flag is set to valid. Otherwise, if the temperature returns within the predetermined range, the temperature change flag is set to invalid. The temperature change flag is stored in, for example, the memory 12, a register (unillustrated) or the like.

The earthquake information transmitting portion 11b in this embodiment updates the expected timer period before the main tremor arrives at predetermined intervals, for example every second, by using the clock circuit 20. For each updating, the earthquake information transmitting portion 11b transmits the latest expected time period to the handset 2 by using the communication control portion 15.

It should be noted that when the earthquake information calculating portion 11a calculates a new expected time period, the earthquake information transmitting portion 11b updates the expected time period based on that new expected time period. At this time, data related to the old expected time period is discarded. Moreover, the fact that the expected time period is updated may be notified to the user by transmitting to the handset 2, a signal indicating that a new expected time period is calculated.

To output an evacuation direction, the evacuation direction portion 11c in this embodiment refers to the temperature change flag stored in the memory 12; if the flag is invalid, the evacuation direction portion 11c makes a normal notification and, if the flag is valid, makes a vague notification. Or, instead of using the flag, a monitoring result, which is outputted by the temperature monitoring portion 11e, may be directly received to determine which of the notifications to be made.

The evacuation direction portion 11c in this embodiment finds a guidance to be used for the evacuation direction, by using the expected time period before the main tremor arrives fed by the earthquake information calculating portion 11a and the estimated seismic intensity. Specific examples of the guidance table will be described later.

### <2-3. Internal Configuration of Handset>

This embodiment employs the same components as in Embodiment 1; however, an evacuation direction portion 21b in this embodiment has a function partially different from Embodiment 1. The evacuation direction portion 21b in this embodiment, unlike in Embodiment 1, does not update the expected time period at predetermined time intervals. Accordingly, every time the evacuation direction portion 21b is fed with the expected time period from the earthquake information acquiring portion 21a, it determines the kind of guidance to be used to output the evacuation direction.

As the evacuation direction portion 11b does, the evacuation direction portion 21b in this embodiment finds the contents of the guidance to be outputted, based not only on the expected time period before the main tremor arrives, which is fed from the earthquake information acquiring portion 21a, but also on the estimated seismic intensity.

### <2-4. External Design of Handset>

This embodiment employs the same design as in Embodiment 1; thus no overlapping description is given.

### <2-5. Structure of Guidance Table>

FIG. 14 shows a guidance table in which the expected time period before the main tremor arrives, the estimated seismic intensity, and the guidance corresponding to the expected time period and estimated seismic intensity are associated with one another. As shown in FIG. 14, the guidance table in this embodiment is composed of three elements, namely an “EXPECTED TIME PERIOD” column, an “ESTIMATED SEISMIC INTENSITY” column, and a “GUIDANCE” column.

The “EXPECTED TIME PERIOD” and “GUIDANCE” columns are the same as in Embodiment 1; thus no overlapping description on them is given here. What makes a difference between the guidance tables shown in FIG. 4 and in Embodiment 1 is the “ESTIMATED SEISMIC INTENSITY” column. The “EXPECTED TIME PERIOD” is composed of a plurality of ranges into which the estimated seismic intensity of the main tremor is categorized based on predetermined values. For example, in the example shown in FIG. 14, with reference to level 5 of the estimated seismic intensity, two ranges, namely “BELOW LEVEL 5” and “LEVEL 5 OR ABOVE.”

Accordingly, the “GUIDANCE” column is not in an one-to-one relationship with the “EXPECTED TIME PERIOD,” and the guidance is uniquely specified by determining two values of the “EXPECTED TIME PERIOD” and “ESTIMATED SEISMIC INTENSITY.” For example, if the expected time period is 15 seconds, and if the estimated seismic intensity is level 4, the third guidance from the top, namely “CHECK SOURCES OF FLAMES & TAKE COVER UNDER DESK” is used. As in Embodiment 1, some or all of the values contained in the “EXPECTED TIME PERIOD,” the “ESTIMATED SEISMIC INTENSITY,” and the “GUIDANCE” columns may be varied by the operation portion 13 or the operation portion 23.

### <2-6. Evacuation Direction Processing>

Next, evacuation direction processing using the base 1 and the handset 2 at the time of receiving an earthquake early warning according to a second embodiment of the present invention will be described with reference to a block diagram in FIG. 10, and flow charts in FIGS. 11 to 13. By addition of common step numbers, no overlapping description will be given of the same processing as in Embodiment 1.

If the start instruction is received in step S110 shown in FIG. 11, the temperature monitoring portion 11e obtains a specific temperature being measured by the temperature sensor 98. As a target temperature to be measured, for example, an ambient temperature or an internal temperature of the base unit 1 is used. Then whether or not the temperature so measured falls within an allowable range is judged. For example, to measure the ambient temperature, an allowable range for that is specified in advance such that its upper limit is 30 degrees centigrade, and that its lower limit is 5 degrees centigrade.

If the temperature measured falls out of the allowable range, the temperature monitoring portion 11e sets the temperature change flag to valid in step S126. Otherwise, if the temperature measured falls within the allowable range, the temperature monitoring portion 11e sets the temperature change flag to invalid in step S127. If no difference is to be made between the flags before and after the setting is made, no such the setting processing may be performed.

After the flag is set in step S126 or in step S127, the detection processing for detecting the earthquake early warning is performed in steps S130 to S150 as in Embodiment 1. If it is judged, in step S150, that the temperature change flag is set to valid, the vague notification is made to both the base unit 1 and handset 2 in step S160 as in Embodiment 1.

If it is judged, in step S150, that the temperature change flag is set to invalid, a transition is made to the flow of processing shown in FIG. 12, in step S172. A connector symbol C3 shown in connection with step S172 and a connector symbol C4 shown in connection with step S173 in FIG. 11 correspond to a connector symbol C3 and a connector symbol C4 shown in FIG. 12, respectively, and connect the flows of the processing with each other.

FIG. 12 shows the flow of processing along which the base unit 1 performs the evacuation direction processing according to the expected time period before the main tremor arrives, and the estimated seismic intensity; the flow is started if the processing proceeds to step S172 in FIG. 11. Steps S310 to S330 are the same as in Embodiment 1 (FIG. 5); thus no overlapping description will be given.

The evacuation direction portion 11c reads the guidance table stored in the memory 12, and then refers to it in step S330; thereafter the evacuation direction portion 11c finds the guidance corresponding to the current expected time period and the estimated seismic intensity based on the values of the expected time period and the estimated seismic intensity, and the guidance table. A sound message, text message, pictogram or the like according to the guidance is outputted by using the display portion 13 and the loudspeaker 18.

For example, if the expected time period is five seconds, the estimated seismic intensity is level 6, and the guidance table is so structured as to contain the contents shown in FIG. 14, the sound message or text image corresponding to the guidance in the lowest row, namely “TAKE COVER UNDER DESK” is outputted. When the display portion 13 is provided with the capability of displaying pictograms, it displays a pictogram signifying one should take cover under a desk.

Subsequently in step S350, the evacuation direction portion 11c updates the expected time period at a time when a predetermined time has elapsed. In step S365, whether or not the current expected time period is equal to or more than 0 is judged. If it is equal to or more than 0, the flow proceeds to step S320 again, the handset 2 continues to be notified of the expected time period, and the evacuation direction continues to be outputted.

Next, a flow of processing performed in the handset 2 if the processing in the base unit 1 proceeds to step S172 in FIG. 11 will be described with reference to a flow chart in FIG. 13. Step S410 is the same as in Embodiment 1 (FIG. 6); thus no overlapping description will be given. If the earthquake early warning is detected to have been received in step S410, the earthquake information acquiring portion 21a extracts from among the earthquake information received from the base unit 1, the estimated seismic intensity and the expected time period before the main tremor arrives. The estimated seismic intensity and the expected time period so extracted are fed to the evacuation direction portion 21b.

Subsequently in step S430, the evacuation direction portion 21b reads the guidance table shown in FIG. 14 from the memory 22, and refers to it. In step S445, from the values of the expected time period and the estimated seismic intensity, and the guidance table, the guidance corresponding to the current expected time period and the estimated seismic intensity is found. Then the sound message, text message, or pictogram according to that guidance is outputted by using the display portion 23 and the loudspeaker 28, and the processing comes to an end.

At that time, if the evacuation direction according to any guidance has already been given, and the guidance found in step S445 is the same as the current guidance, the current evacuation direction processing is continued without newly starting the evacuation direction processing. Thus, it is possible to prevent unnecessary processing in which the sound message, etc. are outputted again from scratch regardless of no change being made in the guidance.

As described above, according to this embodiment, even if the earthquake early warning is received under the circumstance where the accuracy of the clock circuit 20 cannot be assured due to a variation in temperature, it is possible to give an appropriate evacuation direction to the user.

Next, a third embodiment of the present invention will be described with reference to the accompanying drawings.

### Embodiment 3

### <3-1. Construction of Telephone System>

This embodiment employs the same construction as in Embodiment 1; thus no overlapping description is given here.

### <3-2. Internal Configuration of Base Unit>

A base unit 1 in this embodiment is provided with a date/area checking portion 11f as a functional block realized by executing a predetermined program by the control portion 11. An evacuation direction portion 11c in this embodiment has a function partially different from Embodiment 1.

The date/area checking portion 11f checks area information indicating a location where the base unit 1 is installed, and date information retained by the clock circuit 20. The area information and the date information are set in advance by user operation at a time of initial setting of the base unit 1, etc. As a result of checking, if there is no match for the predetermined area and/or date, a date/area flag is set to invalid. Otherwise, if there is a match for the area and/or date, the date/area is set to valid. Incidentally, the date/area flag is stored in, for example, the memory 12, a register (unillustrated), etc.

To output an evacuation direction, the evacuation direction portion 11c in this embodiment refers to the date/area flag stored in the memory 12; if the flag is invalid, the evacuation direction portion 11c makes a normal notification and, if the flag is invalid, makes an vague notification. Or, instead of using the flag, a judgment result, which is outputted by the date/area checking portion 11f, may be directly received to determine which of the notifications to be made.

### <3-3. Internal Configuration of Handset>

This embodiment employs the same configuration as in Embodiment 1; thus no overlapping description is given here.

### <3-4. External Design of Handset>

This embodiment employs the same design as in Embodiment 1; thus no overlapping description is given here.

### <3-5. Structure of Guidance Table>

This embodiment employs the same structure as in Embodiment 1; thus no overlapping description is given here.

### <3-6. Evacuation Direction Processing>

Next, evacuation direction processing performed by using the base unit 1 and the handset 2 at the time of receiving an earthquake early warning according to the third embodiment of the present invention will be described with reference to a block diagram in FIG. 15 and a flow chart in FIG. 16. By addition of common step numbers, no overlapping description will be given of the same processing as in Embodiment 1.

If the start instruction is received in step S110 shown in FIG. 16, the date/area checking portion 11f checks whether or not region setting information stored in the memory 12 matches a predetermined region, in step S121. If there is a match between them, the date/area checking portion 11f sets the date/area flag to valid in step S126. Specifically for example, for the region setting information, names of prefectures, such as Hokkaido, are used. Or, latitude-longitude information, address, telephone numbers, etc. may be used for the location setting information.

If it is judged that such a criterion is not met in step S121, the date/area checking portion 11f checks whether or not the current date matches any of predetermined dates based on calendar information retained by the clock circuit 20. Specifically for example, for the predetermined dates, December 1 to March 31, etc. are set in advance as a criterion. Or for the predetermined dates, roughly a season, such as winter and summer, may be specified, and dates corresponding to that season may be set as a criterion.

If it is judged that the date matches any of the predetermined dates in step S122, the date/area checking portion 11f sets the date/area flag to valid in step S126. If it is judged that the criterion is not met in step S122, the date/area checking portion 11f sets the date/area flag to invalid in step S127. If no difference is made between the flags before and after the setting is made, no such the setting processing may be performed.

Processing from step S130 to step S171 is the same as in Embodiment 1; thus no overlapping description will be given. After it is judged that no earthquake early warning is detected in step S140, or after the notification processing is executed in any of step S160 and steps S170 to S171 (including the flow of the processing in FIG. 5), the date/area checking portion 11f updates the date kept by the clock circuit 20, and judges whether or not the date is changed to a new one.

If the change of the date is detected, the flow proceeds to step S121. If no change of the date is detected, the flow proceeds to step S130. The control portion 11 receives an instruction to stop execution of the evacuation direction processing of the present invention whereby it is possible to terminate the above-described flow of processing performed in sequence.

As described above, according to this embodiment, even if the earthquake early warning is received under the circumstances where the accuracy of the clock circuit 20 cannot be assured due to extremely high or low ambient temperature inherent to an area and season, it is possible to give an appropriate evacuation direction to the user.

Next, a fourth embodiment of the present invention will be described with reference to the accompanying drawings.

### Embodiment 4

### <4-1. Construction of Telephone System>

This embodiment employs the same construction as in Embodiment 1; thus no overlapping description will be given.

### <4-2. Internal Configuration of Base Unit>

A base unit 1 in this embodiment is provided with an evacuation direction registering portion 11g as a functional block realized by executing a predetermined program by the control portion 11. The evacuation direction portion 11c has a function partially different from Embodiment 1. Moreover, the base unit 1 is provided with a flash memory 97 (=storage portion).

The evacuation direction registering portion 11g receives an instruction to select from among image data and sound data stored in the flash memory 97, data to be used by the evacuation direction portion 11c as data for evacuation directions. A result of the selection is stored in the flash memory 97. By referring to that result of the selection, the evacuation direction portion 11c finds the data for the evacuation direction to be outputted. The evacuation direction registering portion 11g also has a capability of receiving image data and sound data from outside and storing them into the flash memory 97. For example, a sound fed from the microphone 19 is stored as a evacuation direction sound.

The flash memory 97 is rewritable, a non-volatile semiconductor memory where no data is erased by turning off the power. The flash memory 97 is a kind of EEPROM, but is different from EEPROM in that rewriting cannot be performed on a per-byte basis, and that a write operation is performed after an erase operation is performed on a per-block basis. In the present invention, the flash memory 97 is used for storing evacuation direction data, etc., which are used by the evacuation direction portion 11c.

When fed with an earthquake early warning, the evacuation direction portion 11c in this embodiment then reads an evacuation direction image and an evacuation direction sound (hereinafter, referred to as “evacuation direction data”) stored in the flash memory 97. The evacuation direction data so read is outputted by using the display portion 13 and the loudspeaker 18 to give an evacuation direction thereby.

### <4-3. Internal Configuration of Handset>

FIG. 18 is a block diagram showing an internal portion of the handset 2 according to the fourth embodiment of the present invention. The handset 2 is so configured as to include, in addition to the control portion 21 to the battery portion 30 in Embodiment 1, a flash memory 31 (=storage portion), a CCD (Charge Coupled Device) camera 32, and an SD card slot 33. The control portion 21 is provided with an evacuation direction registering portion 21c.

The evacuation direction registering portion 21c receives an instruction to select from among image data and sound data stored in the flash memory 31, data to be used by the evacuation direction portion 21b as the evacuation direction data. A result of the selection is stored in the flash memory 31. By referring to that result of the selection, the evacuation direction portion 21b finds the evacuation direction data to be outputted. The evacuation direction registering portion 21c has a capability of receiving image data and sound data from outside and storing them into the flash memory 31.

The CCD camera 32 is a shooting portion that employs a CCD as an image shooting device. The CCD performs photoelectric conversion whereby an optical image (optical information) of a subject formed by a shooting lens unit (unillustrated) is converted into image data composed of different color components, namely R (red), G (green), and B (blue), to output it. Being driven by a timing generator (unillustrated), the CCD is subject to control, etc. for its focus and exposure time to name a few. The image data acquired by the CCD camera 32 is stored in the flash memory 31.

The SD card slot 33 is an interface that connects an external storing medium, namely an SD card memory 99, and that transfers information to it. In the SD card memory 99, for example still images and moving images shot by a digital camera are stored. According to an instruction from the evacuation direction registering portion 21c, the SD card slot 33 duplicates these data into the flash memory 31. Thus, the evacuation direction registering portion 21c can register images and sounds fed from outside as the evacuation direction data.

### <4-4. External Design of Handset>

FIG. 27 is an external appearance diagram showing an external design of the handset 2 according to the fourth embodiment of the present invention. FIG. 27(a) is an external appearance diagram of the handset 2 as seen from its side surface; FIG. 27(b) is an external appearance diagram of the handset 2 as seen from its front surface; FIG. 27(c) is an external appearance of the handset 2 as seen from its bottom surface.

As shown in FIG. 7, the handset 2 is provided with, at its front surface, a display portion 23, an entry portion 24, an antenna device 26, a loudspeaker 28, and a microphone 29. The handset 2 is provided with, in its bottom portion, a rechargeable battery portion 30. The entry portion 24 is provided with a set of plural operation buttons, and is located below the display portion 23 including a liquid crystal panel.

The handset 2 is provided with, at its side surface, a CCD camera 32 and an SD card slot 33. Thus, the handset 2 can shoot evacuation direction images, and can receive the evacuation direction data from outside.

### <4-5. Evacuation Direction Data Selection Screen>

Next, an example of an evacuation direction data selection screen according to the fourth embodiment of the present invention will be described with reference to a screen diagram in FIG. 22.

FIG. 22 shows an example of an evacuation direction data selection screen 80 displayed on the display portion 13 provided in the base unit 1 or on the display portion 23 provided in the handset 2. The screen can be displayed at any time, such as at a time when a setting button incorporated in the entry portion 14 or the entry portion 24 is pressed. As shown in FIG. 22, the evacuation direction data selection screen 80 is so configured as to include sounds and images, which are selectable as the evacuation direction data, a solid-line cursor 81, and a broken-line cursor 82.

The solid-line cursor 81 represents an active cursor shown while the user is manipulating a cross button, etc. The solid-line cursor 81 can be moved up and down; in the example shown in FIG. 22, this is used in selecting an evacuation direction sound. After selection, by pressing a predetermined button, for example, an Set button, the sound so selected is registered as the evacuation direction data.

The broken-line cursor 82 represents an inactive cursor shown while the user is not manipulating. The broken-line cursor 82 is replaced by the solid-line cursor 81 by pressing, for example a left-right button included in the cross button. With this, in the example shown in FIG. 22, an evacuation direction image can be selected and registered. In a case where the display portion is small in size, only part of the evacuation direction data selection screen, for example only a sound selection portion (=left side of the screen) may be displayed and replaced by an image selection portion (=right side of the screen) by pressing a predetermined button.

### <4-6. Evacuation Direction Data Registering Processing>

Next, evacuation direction data registering processing performed by using the base unit 1 and the handset 2 according to the fourth embodiment of the present invention will be described with reference to block diagrams in FIGS. 17 and 18, a flow chart in FIG. 19, and the screen diagram in FIG. 22. The base unit 1 and the handset 2 are different units but perform the processing along the same flow; thus, the following description will illustrate the flow of the processing, taking up the handset 2 as an example.

The flow of the processing shown in FIG. 19 is started by pressing a Set button provided in the entry portion 24, and by making a transition to a mode in which evacuation direction data is set. After the processing is started, the evacuation direction registering portion 21c judges, as its registering method, which to select between a “select mode” and a “storage mode”. The “select mode” is a mode in which the evacuation direction data is selected from among the image data and sound data stored in the flash memory 31 in advance. The “storage mode” is a mode in which new evacuation direction data from outside is stored and registered.

If the “select mode” is selected in step S510, the evacuation direction registering portion 21c makes the evacuation direction data selection screen 80 displayed on the display portion 23. In step S520, the selection of the sound data is received. Moreover in step S530, the selection of the image data is received.

Subsequently in step S540, the evacuation direction registering portion 21c registers the sound data and the image data so selected in the flash memory 31 as the evacuation direction data, and thereafter the current processing comes to an end.

The description continues with reference back to step S510; if the “storage mode” is selected in step S510, the evacuation direction registering portion 21c is brought into a state waiting for the input of sound data for the evacuation direction. When the sound data is fed, for example, by using the microphone 29, the evacuation direction registering portion 21c makes the display portion 23 display a text image saying “Please input a sound,” and is then brought into the state waiting for the input. Or if the sound data is acquired from outside by using the SD card slot 33 or the communication control portion 25, the kind of sound data that can be acquired is displayed on the display portion 23, and thereby the evacuation direction registering portion 21c is brought into the state waiting for data to be acquired, to be specified.

Subsequently in step S560, the evacuation direction registering portion 21c is brought into the state waiting for the input of image data for the evacuation direction. When an image for an evacuation direction is shot, for example, by using the CCD camera 32, the evacuation direction registering portion 21c makes a text image saying “Please shoot an image” displayed on the display portion 23, and is then brought into the state waiting for shooting. In the same way as for the sound data, the evacuation direction registering portion 21c may enter the state waiting for a still or moving image that can be acquired from outside to be specified.

Subsequently in step S570, the evacuation direction registering portion 21c registers the stored sound and image data into the flash memory 31 as the evacuation direction data, and the current processing comes to an end.

### <4-7. Evacuation Direction Processing>

Next, evacuation direction processing performed by using the base unit 1 and the handset 2 at the time of receiving an earthquake early warning according to the fourth embodiment of the present invention will be described with reference to flow charts in FIGS. 20 and 21.

FIG. 20 shows the flow of processing performed in the base unit 1 in the stand-by state to receive an earthquake early warning. The flow of processing shown in FIG. 20 can be started at any time when the power supply of the base unit 1 is activated, and is able to perform communication with the Internet 62. After the processing is started, the earthquake information calculating portion 11a judges whether or not the communication control portion 15 has received an earthquake early warning from the Internet 62, in step S610.

If it is judged that no earthquake early warning has been received, a transition is made to step S610 again, and the earthquake early warning continues to be monitored until it is detected. If the earthquake early warning is detected to have been received, the earthquake information calculating portion 11a analyzes an electric text contained in that earthquake early warning, in step S620. In this way, from various parameters included in the electric text, the estimated seismic intensity, the expected arrival time of the main tremor, etc. are calculated.

Subsequently in step S630, by using the communication portion 15 and the antenna device 16, the earthquake information transmitting portion 11b transmits to one or the plurality of handsets 2, a detected earthquake notification indicating that the earthquake early warning has been detected.

Subsequently in step S640, the evacuation direction portion 11c reads from the flash memory 97, the evacuation direction data that has been registered in advance by the evacuation direction registering portion 11g. The sound and image based on the evacuation direction data are outputted by using the display portion 13 and the loudspeaker 18.

Next, the flow of processing performed in the handset 2 will be described with reference to the flow chart in FIG. 21. The flow of processing shown in FIG. 31 can be started at any time when the handset 2 is in the stand-by state, and is able to perform wireless communication with the base unit 1. After the processing is started, the earthquake information acquiring portion 21a judges whether or not the base unit 1 has received earthquake information through the antenna device 26, in step S710.

If it is judged that no earthquake information has been received, the flow proceeds to step S710 again, and earthquake information continues to be monitored until it is detected. If the earthquake information is detected to have been received, the evacuation direction portion 21b reads from the flash memory 31, the evacuation direction data that has been registered in advance by the evacuation direction registering portion 21c. The sound and image composed of the evacuation direction data are outputted by using the display portion 23 and the loudspeaker 28.

Next, a fifth embodiment of the present invention will be described with reference to the accompanying drawings.

### Embodiment 5

### <5-1. Structure of Telephone System>

This embodiment employs the same structure as in Embodiment 1; thus no overlapping description will be given here.

Although the same components as shown in FIG. 17 in Embodiment 4 are used, the evacuation direction portion 11c and the evacuation direction registering portion 11g have functions partially different from Embodiment 1. The evacuation direction portion 11c in this embodiment finds the evacuation direction data to be used for the evacuation direction, by using an evacuation direction table in which a location where the base unit is installed and the evacuation direction data corresponding to that location are associated with each other. Likewise, the evacuation direction registering portion 11g receives an instruction to select the evacuation direction data by using the evacuation direction table, and registers the evacuation direction data. Incidentally, the evacuation direction table will be described in detail later.

### <5-3. Internal Configuration of Handset>

Although the same components as in FIG. 18 in Embodiment 4 are used, the evacuation direction portion 21b and the evacuation direction registering portion 21c have functions partially different from those in Embodiment 4. The evacuation direction portion 21b and the evacuation direction registering portion 21c have the same functions as the above-described evacuation direction portion 11c and evacuation direction registering portion 11g; thus no overlapping description will be given here.

### <5-4. External Structure of Handset>

This embodiment employs the same structure as in Embodiment 4; thus no overlapping description will be given here.

### <5-5. Evacuation Direction Data Selection Screen>

Next, an example of an evacuation direction data selection screen according to the fifth embodiment of the present invention will be described with reference to FIG. 26.

FIG. 26 shows an example of an evacuation direction data selection screen 90 that is displayed on the display portion 13 provided in the base unit 1 or on the display portion 23 provided in the handset 2. This screen can be displayed at any time such as when the Set button included in the entry portion 14 or the entry portion 24 is pressed. As shown in FIG. 26, the evacuation direction data selection screen 90 is so configured as to include sound data and image data prepared for each of the locations where the communication devices (=base unit 1 or handset 2) are installed, and a cursor 91.

The cursor 91 can be moved up and down by the user using the cross button, etc. By using this, the user selects the location where the communication device is installed, namely the location where an evacuation direction is given. After selection, by pressing a predetermined button, for example the Set button or the like, the sound data and the image data associated with the installation location so selected are registered as the evacuation direction data. For example, in the example shown in FIG. 26, by selecting a living room as the installation location, the sound data “Please take cover under a table” and the image data indicating that one should take cover under a desk are registered as the evacuation direction data.

### <5-6. Evacuation Direction Data Registering Processing>

In this embodiment, the evacuation direction data is registered by using the evacuation direction table. FIG. 25 is a table diagram showing an example of the evacuation direction table. As shown in FIG. 25, the evacuation direction table in this embodiment is composed of three columns, namely an “installation location” column, a “sound data” column, and an “image data” column from the left in this order.

The “installation location” column indicates locations where the communication devices are supposed to be installed and, for example, they include a child's room, a kitchen, a living room, and the like. The “sound data” column indicates file names of the image data that are used according to the installation location. In the example shown in FIG. 25, JPEG-format still-image files and MOV-format moving files are registered.

The evacuation direction registering portions 11g and 21c refer to the evacuation direction table, and thereby make the aforementioned evacuation direction data selection screen 90 displayed. The evacuation direction registering portions 11g and 21c checks the installation location specified by the user on the evacuation direction data selection screen 90 with the evacuation direction table, and thereby finds the file name of the evacuation direction data to be used.

The file names indicated in the “sound data” column and the “image data” column may be changed by the user wherever necessary. The category of installation location may be added and erased. It should be noted that data of the file names to be registered in the table need to be stored in the flash memory 97 (for the case of the handset 2, the flash memory 31) in advance.

### <5-7. Evacuation Direction Processing>

Next, evacuation direction processing performed in the base unit 2 and the handset 2 at the time of receiving an earthquake early warning according to the fifth embodiment of the present invention will be described with reference to flow charts in FIGS. 23 and 24. By addition of common step numbers, no overlapping description will be given of the same processing as in Embodiment 4.

FIG. 23 shows the flow of processing performed in the base unit 1 prepared for the earthquake early warning. The flow of processing shown in FIG. 23 can be started at any time when the power supply of the base unit 1 is activated, and is able to perform communication with the Internet 62. The processing from steps S610 through S630 is the same as in Embodiment 4; no overlapping description will be given.

After step S630 is executed, the evacuation direction portion 11c reads the evacuation direction table from the flash memory 97 in step S650. In step S660, the evacuation direction registering portion 11g finds the evacuation direction data to be used, by checking the installation location fed by the evacuation direction registering portion 11g with the evacuation direction table. Then the sound and image corresponding to the evacuation direction data are outputted by using the display portion 13 and the loudspeaker 18.

Next, the flow of processing performed in the handset 2 will be described with reference to the flow chart in FIG. 24. The flow of the processing shown in FIG. 24 can be started at any time when the handset 2 is in the stand-by state, and is able to perform wireless communication with the base unit 1. The processing in step S710 is the same as in Embodiment 4; thus no overlapping description will be given.

After step S710 is executed, the evacuation direction portion 21b reads the evacuation direction table from the flash memory 31. In step S740, the evacuation direction registering portion 21c checks the installation location fed by the user with the evacuation direction table, and thereby finds the evacuation direction data to be used. Then the sound and image corresponding to the evacuation direction data are outputted by using the display portion 23 and the loudspeaker 28.

### Other Embodiments

The foregoing has specifically described the preferred embodiments and examples of the present invention, but is not meant to limit how the present invention is practiced; the present invention can be practiced with various changes made within the scope of the technical idea of the present invention.

Accordingly, the present invention is applicable to the other embodiments noted below.

(A) Although the above-described embodiments deal with a case where, as the communication lines for the base unit 1 to receive an earthquake early warning, the wired LAN 41 and the Internet 62 are used, any other communications network, such as a dedicated line and a cable television line, may be used to receive an earthquake early warning. Moreover, the earthquake early warning may be acquired from broadcast radio waves such as those used for terrestrial digital broadcasting and BS digital broadcasting.

(B) Although the above-described embodiments deal with the configuration in which individual functional blocks involved in the evacuation direction processing are provided in the base unit 1 and the handsets 2, part of the functional blocks may be realized by external devices connected via networks such as telephone networks and LANs. For example, a message table referred to by the evacuation direction portion 11c may be stored in an information processing apparatus (network server, etc.) located on a network. With this design, for example when it is desired to change the contents of the message table, since that table is shared among a plurality of communication devices, it is possible to accomplish such a change with a single operation. Thus, it is possible to save trouble of changing the contents of the message table for each device.

(C) Although the above-described embodiments deal with a case where, as the communication device incorporating the capability of notifying of an earthquake early warning according to the present invention, the cordless telephones including the base unit 1 and the handset 2 are taken up as an example, any other devices may be adopted in practicing the present invention so long as they serve as communication devices capable of establishing connection with a wide area communications network, and of receiving an earthquake early warning. For example, the present invention may be practiced in facsimiles, mobile phones equipped with wireless LAN connection capability, Internet phones, IP telephones equipped with an IP-communication-enabled handset, navigation apparatuses, applications implemented on PDAs and notebook personal computers, and the like.

(D) Although the above-described embodiments deal with a case where the individual functional blocks in the base unit 1 and the handset 2, which are involved in the evacuation direction processing of the present invention, are realized by executing programs on the arithmetic operation unit such as microprocessor, the individual functional blocks may be realized by a plurality of circuits.

(E) Although the above-described embodiments deal with a case where, as the handset involved in the evacuation direction processing of the present invention, the handset 2 equipped with wireless communication capability is taken up as an example, the evacuation direction processing of the present invention may be performed in a handset with no wireless communication capability but with a wired communication capability alone.

(F) Although the above-described embodiments deal with a case where the guidance table has its contents of the evacuation direction changed every 10 seconds within the expected time period, the contents of the evacuation direction may be changed at any other time intervals, for example, every five seconds. Moreover, the values contained in the “ESTIMATED SEISMIC INTENSITY” column may be changed wherever necessary according to applications.

(G) Although the above-described embodiments deal with a case where, as the means for acquiring the evacuation direction data from outside, the microphone 29, the CCD camera 32, and the SD card slot 33 are taken up as examples, the evacuation direction data may be acquired through any means other than those described above, such as a USB connecting terminal, infrared input terminal, external device and the Internet connected to a communications network.

1. A communication device comprising:
a first communication portion capable of establishing connection with a communications network;
an earthquake information calculating portion receiving an earthquake early warning from the communications network by using the first communication portion, and calculating earthquake information including an expected time period before a main tremor arrives;
an evacuation direction portion outputting an evacuation direction image or an evacuation direction sound based on the earthquake information by using a display portion and a sound outputting portion;
a timekeeping portion keeping time; and
a time adjusting portion adjusting the timekeeping portion, wherein
if the earthquake information calculating portion receives the earthquake early warning under circumstances where the time adjusting portion cannot assure accuracy of the timekeeping portion,
the evacuation direction portion is prohibited from outputting an evacuation direction image and an evacuation direction sound associated with the earthquake information calculated, by the earthquake information calculating portion, based on the time, and
the evacuation direction portion outputs an evacuation direction image or an evacuation direction sound unassociated with the earthquake information.

2. The communication device according to claim 1, wherein
the time adjusting portion judges that the accuracy of the timekeeping portion cannot be assured, if the time adjusting portion performs communication with an NTP (Network Time Protocol) server by using the first communication portion, and fails to acquire time information from the server, or if the time adjusting portion detects that the timekeeping portion is disabled.

3. The communication device according to claim 1, further comprising:
a temperature measuring portion measuring temperature;
a temperature monitoring portion monitoring whether or not the temperature measured by the temperature measuring portion is within a predetermined range;
a date/area checking portion judging whether or not date information acquired from the timekeeping portion matches a predetermined date, and judging whether or not area information of the communication device stored in a storage portion matches a predetermined area, wherein
if the earthquake information calculating portion receives the earthquake early warning under circumstances where the temperature monitoring portion detects that the temperature measured is out of the range or the date/area checking portion judges that there is a match for the date or the area,
the evacuation direction portion is prohibited from outputting the evacuation direction image and the evacuation direction sound associated with earthquake information calculated, by the earthquake information calculating portion, based on the time, and
the evacuation direction portion outputs the evacuation direction image or the evacuation direction sound unassociated with the earthquake information.

4. The communication device according to claim 1, further comprising:
a storage portion storing first evacuation direction data including the evacuation direction image or the evacuation direction sound associated with the time, and second evacuation direction data including the evacuation direction image or the sound unassociated with the time, wherein
if the earthquake information calculating portion receives the earthquake early warning under circumstances where the time adjusting portion cannot assure the accuracy of the timekeeping portion, the evacuation direction portion outputs, as an evacuation direction, the evacuation direction image or the evacuation direction sound by using the second evacuation direction data.

5. The communication device according to claim 1, wherein
the evacuation direction portion
comprises, as such the evacuation direction image or the evacuation direction sound, a plurality of kinds of evacuation direction images or evacuation direction sounds and,
based on the expected time period, finds and outputs the evacuation direction image or the evacuation direction sound to be used for an evacuation direction.

6. The communication device according to claim 5, further comprising:
a storage portion storing an association table in which the expected time period and contents of the evacuation direction corresponding to the expected time period are associated with each other, wherein
the evacuation direction portion
finds the contents of the evacuation direction according to the expected time period by referring to the association table and,
based on a result found, outputs the evacuation direction image or the evacuation direction sound.

7. The communication device according to claim 6, wherein
the evacuation direction portion
updates the expected time period as time elapses, and
for each updating, checks the expected time period so updated with the association table, and then judges whether or not it is necessary to change the evacuation direction image or the evacuation direction sound to be outputted.

8. The communication device according to claim 5, wherein
the evacuation direction portion determines the evacuation direction image or the evacuation direction sound to be used for the evacuation direction, based on the estimated seismic intensity and the expected time period included in the earthquake information.

9. The communication device according to claim 1, comprising:
a main communication device comprising
the first communication portion,
the earthquake information calculating portion,
the evacuation direction portion,
the timekeeping portion,
the time adjusting portion, and
an earthquake information transmitting portion transmitting the earthquake information and a status of the accuracy of the timekeeping portion, namely whether or not the accuracy of the timekeeping portion can be assured, by using the first communication portion; and
a subsidiary communication device comprising
a second communication portion capable of performing communication with the main communication device,
an earthquake information acquiring portion acquiring, from information received by using the second communication portion, the earthquake information and the status of the accuracy of the timekeeping portion, namely whether or not the accuracy of the timekeeping portion can be assured, and
the evacuation direction portion.

10. The communication device according to claim 9, wherein
the first communication portion comprises a wireless communication portion capable of performing communication with a wireless communications network,
the earthquake information transmitting portion transmits to the subsidiary communication device, the earthquake information and the status of the accuracy of the timekeeping portion, namely whether or not the accuracy of the timekeeping portion can be assured, by using the wireless communication portion provided in the first communication portion,
the second communication portion comprises a wireless communication portion capable of performing communication with the wireless communication network, and
the earthquake information receiving portion receives the earthquake information and the status of the accuracy of the timekeeping portion, namely whether or not the accuracy of the timekeeping portion can be assured, by using the wireless communication portion provided in the second communication device.

11. The communication device according to claim 9, wherein
the subsidiary communication device further comprises
a storage portion storing an association table in which the expected time period and contents of the evacuation direction are associated with each other, wherein
the earthquake information transmitting portion
updates the expected time period as the time elapses and,
for each updating, transmits the expected time period so updated to the subsidiary communication device by using the first communication portion, and
the evacuation direction portion provided in the subsidiary communication device
finds the contents of the evacuation direction according to the expected time period by referring to the association table and, based on a result found, outputs the evacuation direction image or the evacuation direction sound, and
for each receiving of the expected time period, checks the expected time period with the association table, and then judges whether or not it is necessary to change the evacuation direction image or the evacuation direction sound to be outputted.

12. A communication device comprising:
a first communication portion capable of establishing connection with a communications network;
a warning receiving portion receiving an earthquake early warning from the communications network by using the first communication portion; and
an evacuation direction portion outputting an evacuation direction image or an evacuation direction sound by using a display portion or a sound outputting portion, at a time of receiving the earthquake early warning, wherein
the evacuation direction portion incorporates, as such the evacuation direction image or the evacuation direction sound, a plurality of kinds of evacuation direction images or evacuation direction sounds, and the communication device comprises an evacuation direction registering portion receiving a result of specification of the evacuation direction image or the evacuation direction sound to be used by the evacuation direction portion at the time of receiving the earthquake early warning.

13. The communication device according to claim 12, further comprising:
a storage portion, wherein
the evacuation direction registering portion receives
image data or sound data to be stored in the storage portion, and
a result of selection of the evacuation direction image or the evacuation direction sound used by the evacuation direction portion, from among the image data and sound data stored in the storage portion.

14. The communication device according to claim 13, wherein
the storage portion stores an evacuation direction table in which an installation location of the communication device, and the evacuation direction image or the evacuation direction sound are associated with each other,
the evacuation direction registering portion receives a result of selection of the installation location contained in the evacuation direction table, and
the evacuation direction portion finds and outputs the evacuation direction image or sound associated with the installation location thus selected, from the evacuation direction table.

15. The communication device according to claim 12, comprising:
a main communication device including
the first communication portion,
the warning receiving portion,
the evacuation direction portion,
the evacuation direction registering portion,
an earthquake detection transmitting portion transmitting a detection notification that an earthquake early warning is detected, by using the first communication portion; and
a subsidiary communication device including
a second communication portion capable of performing communication with the main communication device,
an earthquake detection receiving portion receiving the detection notification by using the second communication portion,
the evacuation direction portion, and
the evacuation direction registering portion.

16. The communication device according to claim 15, wherein
the first communication portion is provided with a wireless communication portion capable of establishing connection with a wireless communications network,
the earthquake detection transmitting portion transmits the detection notification by using the wireless communication portion provided in the first communication portion,
the second communication portion is provided with a wireless communication portion capable of establishing connection with the wireless communications network, and
the earthquake detection receiving portion receives the detection notification by using the wireless communication portion of the second communication portion.
